(19) United States
(12) Patent Application Publication
(10) Pub. No.: US 2020/0198341 A1
(43) Pub. Date: Jun. 25, 2020

(54) LIQUID EJECTING HEAD AND LIQUID EJECTING APPARATUS

(71) Applicant: SEIKO EPSON CORPORATION, Tokyo (JP)

(72) Inventor: Yuma FUKUZAWA, MATSUMOTO-SHI (JP)

(21) Appl. No.: 16/719,060

(22) Filed: Dec. 18, 2019

(30) Foreign Application Priority Data
Dec. 21, 2018 (JP) 2018239219

(51) Int. Cl. B41J 2/14

(52) U.S. Cl. CPC B41J 2/1404; B41J 2/14145

(57) ABSTRACT

A liquid ejecting head includes first and second individual flow paths arranged side by side along a first direction; a first nozzle communicating with the first individual flow path; a second nozzle communicating with the second individual flow path; and a first common liquid chamber coupled to one ends of the first and second individual flow paths. The first individual flow path includes a first pressure chamber in which an energy generating element is provided, and a first communication path through which the first pressure chamber communicates with the first nozzle. In a plan view toward an opening surface of the nozzle, in the first communication path, an end portion close to the first nozzle and another end portion close to the first pressure chamber are disposed at positions which do not overlap each other.

The present application is based on, and claims priority from JP Application Serial Number 2018-239219, filed Dec. 21, 2018, the disclosure of which is hereby incorporated by reference herein in its entirety.

### BACKGROUND

### 1. Technical Field

The present disclosure relates to a liquid ejecting head and a liquid ejecting apparatus which eject a liquid from a nozzle, particularly, to an ink jet type recording head and an ink jet type recording apparatus which discharge an ink as a liquid.

### 2. Related Art

As a liquid ejecting head that ejects a liquid, there is known an ink jet type recording head that performs printing by discharging an ink as a liquid onto a printed medium.

The ink jet type recording head includes an individual flow path having a pressure chamber that communicates with a nozzle, a common liquid chamber that communicates in common with a plurality of the individual flow paths, and an energy generating element such as a piezoelectric actuator that induces a change in the pressure of the ink in the pressure chamber. If the energy generating element induces a change in the pressure of the ink in the pressure chamber, ink droplets are discharged from the nozzle.

In order to increase the number of the nozzles or the density of the nozzles in the ink jet type recording head described above, there is proposed a configuration where two rows of the pressure chambers are provided in one flow path substrate (for example, refer to JP-A-2012-143948).

However, there is a demand for increasing the size of the common liquid chamber without increasing the size of the flow path substrate.

The above-mentioned problem exists not only in the ink jet type recording head, similarly but also in liquid ejecting heads that eject liquids other than an ink.

### SUMMARY

An advantage of some aspects of the present disclosure is to provide a liquid ejecting head and a liquid ejecting apparatus in which a common liquid chamber can be enlarged without the size of a flow path substrate being increased.

According to an aspect of the present disclosure, there is provided a liquid ejecting head including first and second individual flow paths arranged side by side along a first direction; a first nozzle communicating with the first individual flow path; a second nozzle communicating with the second individual flow path; and a first common liquid chamber coupled to one ends of the first and second individual flow paths, in which the first and second nozzles have openings in a nozzle surface having a second direction as a normal direction, the first individual flow path includes a first pressure chamber in which an energy generating element is provided, and a first communication path through which the first pressure chamber communicates with the first nozzle, the second individual flow path includes a second pressure chamber in which the energy generating element is provided, and a second communication path through which the second pressure chamber communicates with the second nozzle, and when seen along the second direction, in the first communication path, an end portion close to the first nozzle and another end portion close to the first pressure chamber are disposed at positions which do not overlap each other.

In addition, according to another aspect, there is provided a liquid ejecting apparatus including the liquid ejecting head described in the aspect.

### BRIEF DESCRIPTION OF THE DRAWINGS

FIG. 1 is a plan view of a recording head according to Embodiment 1 of the present disclosure.

FIG. 2 is a cross-sectional view of the recording head according to Embodiment 1 of the present disclosure.

FIG. 3 is a cross-sectional view of the recording head according to Embodiment 1 of the present disclosure.

FIG. 4 is a cross-sectional view of a recording head according to Embodiment 2 of the present disclosure.

FIG. 5 is a cross-sectional view of the recording head according to Embodiment 2 of the present disclosure.

FIG. 6 is a diagram schematically illustrating flow paths according to Embodiment 2 of the present disclosure.

FIG. 7 is a cross-sectional view illustrating a recording head according to an embodiment of the present disclosure.

FIG. 8 is a cross-sectional view illustrating the recording head according to the embodiment of the present disclosure.

FIG. 9 is a cross-sectional view illustrating a recording head according to an embodiment of the present disclosure.

FIG. 10 is a cross-sectional view illustrating the recording head according to the embodiment of the present disclosure.

FIG. 11 is a view illustrating a schematic configuration of a recording apparatus according to one embodiment of the present disclosure.

### DESCRIPTION OF EXEMPLARY EMBODIMENTS

Hereinafter, the present disclosure will be described in detail based on embodiments.

### Embodiment 1

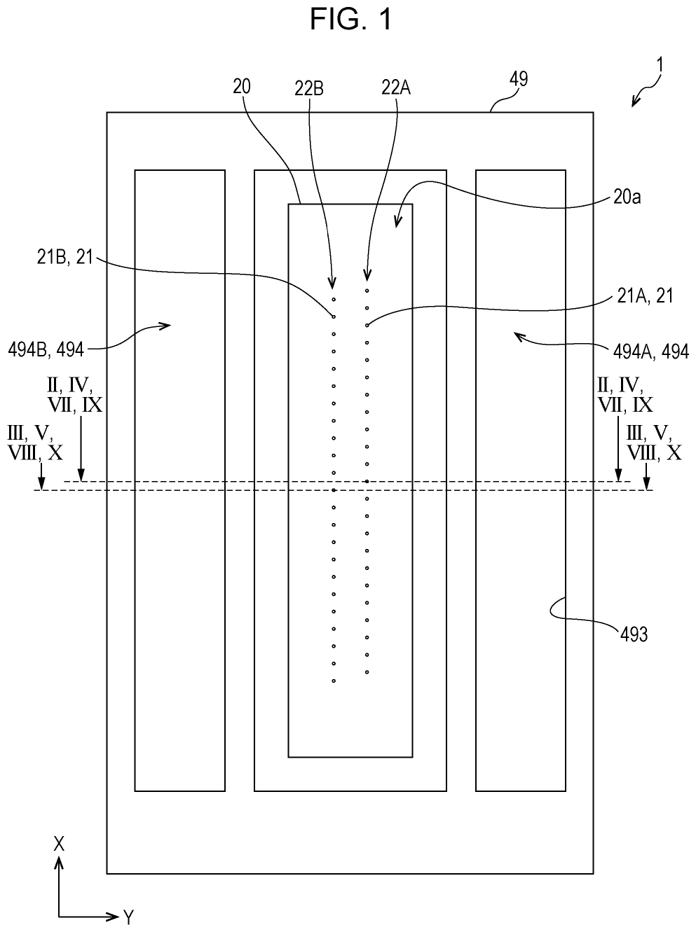

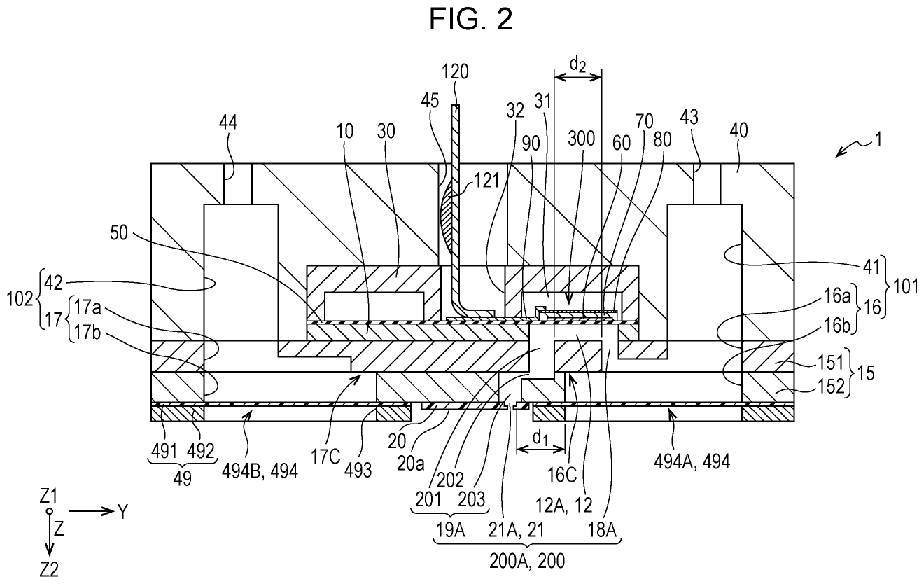

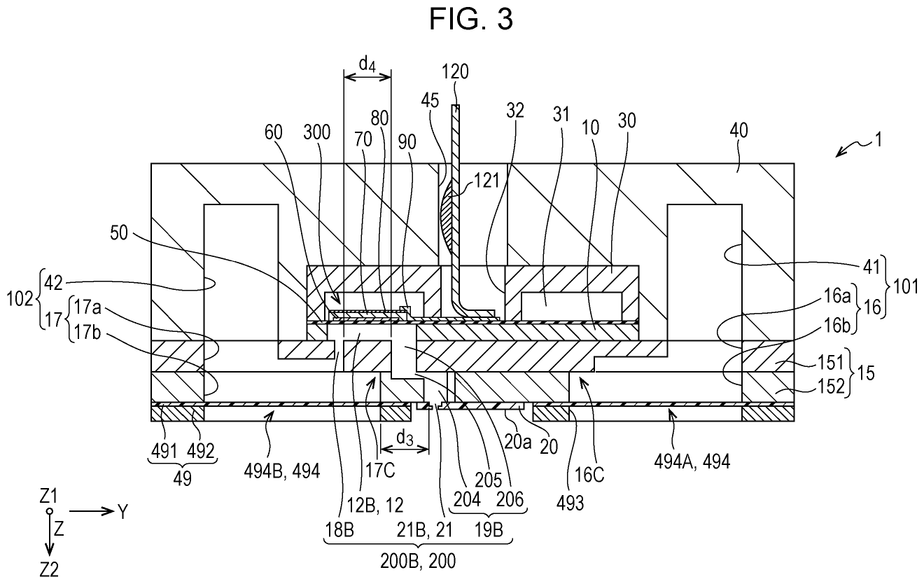

An ink jet type recording head which is one example of a liquid ejecting head of an embodiment will be described with reference to FIGS. 1 to 3. Incidentally, FIG. 1 is a plan view of the ink jet type recording head which is one example of a liquid ejecting head according to Embodiment 1 of the present disclosure, which is seen from a nozzle surface side. FIG. 2 is a cross-sectional view taken along a line II-II in FIG. 1. FIG. 3 is a cross-sectional view taken along a line III-III in FIG. 1.

An ink jet type recording head 1 (hereinafter, referred to simply also as a recording head 1) which is one example of the liquid ejecting head of the embodiment includes, as illustrated, a plurality of members as a flow path substrate such as a flow path formation substrate 10, a communication plate 15, a nozzle plate 20, a protection substrate 30, a case member 40, and a compliance substrate 49.

The flow path formation substrate 10 is made of a single crystal silicon substrate, and a vibrating plate 50 is formed on one surface thereof. The vibrating plate 50 may be a single layer or a lamination layer selected from a silicon dioxide layer or a zirconium oxide layer.

The flow path formation substrate 10 is provided with a plurality of pressure chambers 12 which form individual flow paths 200 and are partitioned off by a plurality of partition walls. The plurality of pressure chambers 12 are arranged side by side at a predetermined pitch along a direction where a plurality of nozzles 21 discharging an ink are arranged side by side. Hereinafter, the direction is referred to as a side by side arrangement direction of the nozzle 21, a side by side arrangement direction of the pressure chamber 12, or a first direction X. In addition, the flow path formation substrate 10 is provided with a plurality of rows of the pressure chambers 12 that are arranged side by side in the first direction X, and in the embodiment, two rows are provided. A row arrangement direction where the plurality of rows of the pressure chambers 12 are provided is referred to, hereinafter, as a second direction Y. Incidentally, in the embodiment, a portion between the pressure chambers 12 which are arranged side by side in the first direction X of the flow path formation substrate 10 is referred to as a partition wall. The partition wall is formed along the second direction Y. Namely, the partition wall refers to a portion that overlaps the pressure chamber 12 in the second direction Y of the flow path formation substrate 10.

In addition, in the embodiment, in two rows of the pressure chambers 12, the pressure chamber 12 in one row is referred to as a first pressure chamber 12A, and the pressure chamber 12 in the other row is referred to as a second pressure chamber 12B. The first pressure chamber 12A and the second pressure chamber 12B are disposed at positions which do not overlap each other in a plan view from the first direction X. In addition, the first pressure chambers 12A and the second pressure chambers 12B are disposed in a so-called staggered pattern where the first pressure chambers 12A deviate from the second pressure chamber 12B in the first direction X. In the embodiment, the row in which the first pressure chambers 12A are arranged side by side in the first direction X, and the row in which the second pressure chambers 12B are arranged side by side in the first direction X are disposed at positions which deviate by half a pitch from each other in the first direction X. Incidentally, part of the first pressure chamber 12A and part of the second pressure chamber 12B may be disposed at positions which overlap each other in the plan view from the first direction X.

In addition, in the embodiment, a direction orthogonal to both of the first direction X and the second direction Y is referred to as a third direction Z. A side close to the case member 40 with respect to the nozzle plate 20 (to be described in detail later) is referred to as a Z1 side, and a side close to the nozzle plate 20 with respect to the case member 40 is referred to as a Z2 side. Incidentally, the first direction X, the second direction Y, and the third direction Z are directions orthogonal to each other, but are not specifically limited, and may be directions intersecting each other at angles other than the orthogonal angle.

Incidentally, in the embodiment, the flow path formation substrate 10 is provided only with the pressure chamber 12, but may be provided with a flow path resistance application portion having a flow path cross-sectional area smaller than that of the pressure chamber 12 so as to apply a flow path resistance to the ink to be supplied to the pressure chamber 12.

The vibrating plate 50 is formed, as described above, on the Z1 side which is one surface side of the flow path formation substrate 10 described above in the third direction Z. A piezoelectric actuator 300 is formed by laminating a first electrode 60, a piezoelectric layer 70, and a second electrode 80 on the vibrating plate 50 by deposition and lithography. In the embodiment, the piezoelectric actuator 300 is an energy generating element that induces a change in the pressure of the ink in the pressure chamber 12. Herein, the piezoelectric actuator 300 is referred to also as a piezoelectric element, and refers to a portion including the first electrode 60, the piezoelectric layer 70, and the second electrode 80. Generally, either one electrode of the piezoelectric actuator 300 is configured as a common electrode, and the other electrode and the piezoelectric layer 70 are formed for each of the pressure chambers 12 by patterning. In the embodiment, the first electrode 60 is formed as a common electrode of the piezoelectric actuator 300, and the second electrode 80 is formed as an individual electrode of the piezoelectric actuator 300, but even though the configuration becomes reversed for the reasons of drive circuits or wirings, there is no problem. Incidentally, in the example described above, the vibrating plate 50 and the first electrode 60 act as a vibrating plate. However, naturally, the present disclosure is not limited to this configuration, for example, the vibrating plate 50 may not be provided, and only the first electrode 60 may act as a vibrating plate. In addition, the piezoelectric actuator 300 may serve substantially as a vibrating plate.

In addition, lead electrodes 90 are coupled to the second electrodes 80 of the piezoelectric actuators 300 described above, and a voltage is selectively applied to the piezoelectric actuators 300 via the lead electrodes 90.

In addition, the protection substrate 30 is joined to a surface of the flow path formation substrate 10, on which the piezoelectric actuator 300 is provided.

A piezoelectric actuator holding portion 31 having a space not to obstruct the motion of the piezoelectric actuator 300 is provided in a region of the protection substrate 30, which faces the piezoelectric actuator 300. The piezoelectric actuator holding portion 31 may have a space not to obstruct the motion of the piezoelectric actuator 300, and the space may be sealed or may not be sealed. In addition, in the embodiment, the piezoelectric actuator holding portion 31 is independently provided for each row of a plurality of the piezoelectric actuators 300 that are arranged side by side in the first direction X. Namely, the piezoelectric actuator holding portion 31 is formed having a size to integrally cover a row of the plurality of piezoelectric actuators 300 that are arranged side by side in the first direction X. Naturally, the piezoelectric actuator holding portion 31 is not specifically limited to the configuration, and may individually cover the piezoelectric actuator 300, or may cover each group formed of two or more piezoelectric actuators 300 that are arranged side by side in the first direction X.

Preferably, a material, for example, a glass or ceramic material having substantially the same coefficient of thermal expansion as that of the material of the flow path formation substrate 10 is used as the material of the protection substrate 30 described above. In the embodiment, the protection substrate 30 is formed of a single crystal silicon substrate which is the same material as that of the flow path formation substrate 10.

In addition, the protection substrate 30 is provided with a through hole 32 penetrating the protection substrate 30 in the third direction Z. The vicinity of an end portion of the lead electrode 90 leading out from each of the piezoelectric actuators 300 extends so as to be exposed in the through hole 32, and is electrically coupled to a flexible cable 120 in the through hole 32. The flexible cable 120 is a wiring substrate having flexibility, and in the embodiment, a drive circuit 121 which is a semiconductor element is mounted thereon. Incidentally, the lead electrode 90 may be electrically coupled to the drive circuit 121 without via the flexible cable 120. In addition, the protection substrate 30 may be provided with a flow path.

In addition, the case member 40 is fixed to a Z1 side of the protection substrate 30. The case member 40 is provided to be joined to a surface side of the protection substrate 30, which is opposite to the flow path formation substrate 10, and to be joined also to the communication plate 15 (to be described later).

The case member 40 described above is provided with a first liquid chamber portion 41 forming part of a first common liquid chamber 101, and a second liquid chamber portion 42 forming part of a second common liquid chamber 102. The first liquid chamber portion 41 and the second liquid chamber portion 42 are provided on both sides in the second direction Y, respectively, where two rows of the pressure chambers 12 are interposed therebetween.

Each of the first liquid chamber portion 41 and the second liquid chamber portion 42 has a recessed shape that opens in a Z2 side surface of the case member 40, and is continuously provided over the plurality of pressure chambers 12 that are arranged side by side in the first direction X.

In addition, two inlet ports 43 are provided in a Z1 side surface of the case member 40, and communicate with the first liquid chamber portion 41 and the second liquid chamber portion 42, respectively.

Furthermore, the case member 40 is provided with a coupling port 45 which communicates with the through hole 32 of the protection substrate 30, and into which the flexible cable 120 is inserted.

On the one hand, the communication plate 15, the nozzle plate 20, and the compliance substrate 49 are provided on the Z2 side that is a surface side of the flow path formation substrate 10, which is opposite to the protection substrate 30.

In the embodiment, the communication plate 15 is configured such that a first communication plate 151 and a second communication plate 152 are laminated on top of each other in the third direction Z. The first communication plate 151 is provided close to the flow path formation substrate 10, namely, on the Z1 side in the third direction Z. The second communication plate 152 is provided close to the nozzle plate 20, namely, on the Z2 side in the third direction Z.

The first communication plate 151 and the second communication plate 152 forming the communication plate 15 described above can be manufactured of a metallic material such as stainless steel, a glass material, or a ceramic material, or the like. Incidentally, preferably, a material having substantially the same coefficient of thermal expansion as that of the material of the flow path formation substrate 10 is used as the material of the communication plate 15. In the embodiment, the communication plate 15 is formed of a single crystal silicon substrate which is the same material as that of the flow path formation substrate 10.

The communication plate 15 is, as will be described in detail later, provided with a first communication portion 16 and a second communication portion 17 which form part of the first common liquid chamber 101 and part of the second common liquid chamber 102, respectively. In addition, the communication plate 15 is, as will be described in detail later, provided with a flow path through which the first common liquid chamber 101 communicates with the pressure chamber 12, a flow path through which the pressure chamber 12 communicates with the nozzle 21, and a flow path through which the nozzle 21 communicates with the second common liquid chamber 102. The flow paths provided in the communication plate 15 form part of the individual flow path 200.

The nozzle plate 20 is provided with the plurality of nozzles 21 which communicate with the outside and communicate with the pressure chambers 12. In the embodiment, as illustrated in FIG. 1, the plurality of nozzles 21 are disposed in a so-called staggered pattern where a first nozzle row 22A in which the plurality of nozzles 21 are arranged side by side in the first direction X and a second nozzle row 22B in which the plurality of nozzles 21 are arranged side by side in the first direction X are arranged side by side in the second direction Y, and the first nozzle row 22A and the second nozzle row 22B deviate from each other in the first direction X so as not to be at the same positions in the second direction Y. In the embodiment, the nozzle 21 of the first nozzle row 22A is referred to as a first nozzle 21A, and the nozzle 21 of the second nozzle row 22B is referred to as a second nozzle 21B. The first nozzle 21A of the first nozzle row 22A communicates with the first pressure chamber 12A. In addition, the second nozzle 21B of the second nozzle row 22B communicates with the second pressure chamber 12B. Incidentally, the first nozzle row 22A and the second nozzle row 22B may line up on a straight line in the first direction X.

In addition, the communication plate 15 has the first communication portion 16 forming part of the first common liquid chamber 101, and the second communication portion 17 forming part of the second common liquid chamber 102.

The first communication portion 16 is provided at a position to overlap the first liquid chamber portion 41 of the case member 40 in the third direction Z, and is provided to be open in both of a Z1 side surface and a Z2 side surface of the communication plate 15. The first communication portion 16 communicates with the first liquid chamber portion 41 on the Z1 side to form the first common liquid chamber 101. Namely, the first common liquid chamber 101 is formed of the first liquid chamber portion 41 of the case member 40 and the first communication portion 16 of the communication plate 15. In addition, the first communication portion 16 extends in the second direction Y to a position on the Z2 side to overlap the pressure chamber 12 in the third direction Z.

In addition, the first communication portion 16 forming the first common liquid chamber 101 includes a first narrow width portion 16a provided on the Z1 side which is a side close to the pressure chamber 12 in the third direction Z, and a first wide width portion 16b provided close to the nozzle 21.

The first narrow width portion 16a is provided in the first communication plate 151 so as to open facing the second communication plate 152, and the first wide width portion 16b is provided to penetrate the second communication plate 152 in the third direction Z.

In addition, the first narrow width portion 16a and the first wide width portion 16b are provided having the same width in the first direction X, and the first wide width portion 16b is formed having a width in the second direction Y wider than the width of the first narrow width portion 16a. In addition, the first wide width portion 16b is provided such that the width thereof is further widened toward the nozzle 21 than the first narrow width portion 16a. Namely, an end portion of the first wide width portion 16b which is opposite to the nozzle 21 in the second direction Y is provided at the same position as the position of a corresponding end portion of the first narrow width portion 16a, and an end portion of the first wide width portion 16b which is close to the nozzle 21 in the second direction Y is disposed outside a corresponding end portion of the first narrow width portion 16a. Accordingly, the width of an opening, which is an opening of the first common liquid chamber 101 which is close to the nozzle 21 in the third direction Z, of the first wide width portion 16b is further widened toward the nozzle 21 than the width of an opening of the first narrow width portion 16a which is an opening close to the pressure chamber 12. In addition, a first step 16c which is a step formed by the first narrow width portion 16a and the first wide width portion 16b is provided in a side wall of the first communication portion 16 which is close to the nozzle 21.

The second communication portion 17 is provided at a position to overlap the second liquid chamber portion 42 of the case member 40 in the third direction Z, and is provided to be open in both of the Z1 side surface and the Z2 side surface of the communication plate 15. The second communication portion 17 communicates with the second liquid chamber portion 42 on the Z1 side to form the second common liquid chamber 102. Namely, the second common liquid chamber 102 is formed of the second liquid chamber portion 42 of the case member 40 and the second communication portion 17 of the communication plate 15. In addition, the second communication portion 17 extends in the second direction Y to a position on the Z2 side to overlap the pressure chamber 12 in the third direction Z.

The second communication portion 17 forming the second common liquid chamber 102 includes a second narrow width portion 17a provided on the Z1 side which is a side close to the pressure chamber 12 in the third direction Z, and a second wide width portion 17b provided close to the nozzle 21.

The second narrow width portion 17a is provided in the first communication plate 151 so as to open facing the second communication plate 152, and the second wide width portion 17b is provided to penetrate the second communication plate 152 in the third direction Z.

In addition, the second narrow width portion 17a and the second wide width portion 17b are provided having the same width in the first direction X, and the second wide width portion 17b is formed having a width in the second direction Y wider than the width of the second narrow width portion 17a. In addition, the second wide width portion 17b is provided such that the width thereof is further widened toward the nozzle 21 than the second narrow width portion 17a. Namely, an end portion of the second wide width portion 17b which is opposite to the nozzle 21 in the second direction Y is provided at the same position as the position of a corresponding end portion of the second narrow width portion 17a, and an end portion of the second wide width portion 17b which is close to the nozzle 21 in the second direction Y is disposed outside a corresponding end portion of the second narrow width portion 17a. Accordingly, the width of an opening, which is an opening of the second common liquid chamber 102 which is close to the nozzle 21 in the third direction Z, of the second wide width portion 17b is further widened toward the nozzle 21 than the width of an opening of the second narrow width portion 17a which is an opening close to the pressure chamber 12. In addition, a second step 17c which is a step formed by the second narrow width portion 17a and the second wide width portion 17b is provided in a side wall of the second communication portion 17 which is close to the nozzle 21.

The compliance substrate 49 having a compliance portion 494 is provided on the Z2 side surface of the communication plate 15, in which the first communication portion 16 and the second communication portion 17 open. The compliance substrate 49 seals openings of the first common liquid chamber 101 and the second common liquid chamber 102, which are close to a nozzle surface 20a, namely, seals the first wide width portion 16b and the second wide width portion 17b.

In the embodiment, the compliance substrate 49 described above includes a sealing film 491 made of a thin film having flexibility, and a fixation substrate 492 made of a hard material such as metal. Since each of regions of the fixation substrate 492 which face the first common liquid chamber 101 and the second common liquid chamber 102 becomes an opening portion 493 formed by completely removing the regions in a thickness direction, part of a wall surface of each of the first common liquid chamber 101 and the second common liquid chamber 102 becomes the compliance portion 494 which is a flexible portion sealed only with the sealing film 491 having flexibility. In the embodiment, the compliance portion 494 provided in the first common liquid chamber 101 is referred to as a first compliance portion 494A, and the compliance portion 494 provided in the second common liquid chamber 102 is referred to as a second compliance portion 494B. As described above, if the compliance portion 494 is provided in part of the wall surface of each of the first common liquid chamber 101 and the second common liquid chamber 102, the compliance portion 494 is capable of, by being deformed, absorbing a fluctuation in the pressure of the ink in the first common liquid chamber 101 and the second common liquid chamber 102.

In addition, in the embodiment, in the first communication portion 16 forming the first common liquid chamber 101, the opening area of the first wide width portion 16b is larger than the opening area of the first narrow width portion 16a. Therefore, compared to the case where the first narrow width portion 16a opens close to the nozzle 21 and the first compliance portion 494A is provided, it is possible to provide the first compliance portion 494A in a relatively wide opening area of the first wide width portion 16b, and it is possible to increase the area of the first compliance portion 494A.

Similarly, in the second communication portion 17 forming the second common liquid chamber 102, the opening area of the second wide width portion 17b is larger than the opening area of the second narrow width portion 17a. Therefore, compared to the case where the second narrow width portion 17a opens close to the nozzle 21 and the second compliance portion 494B is provided, it is possible to provide the second compliance portion 494B in a relatively wide opening area of the second wide width portion 17b, and it is possible to increase the area of the second compliance portion 494B.

In addition, in the embodiment, since the first common liquid chamber 101 and the second common liquid chamber 102 are provided so as to open on the Z2 side on which the nozzle 21 opens, the nozzle plate 20 and the compliance portion 494 are disposed on the Z2 side which is the same side with respect to the individual flow path 200 having the pressure chamber 12 and the nozzle 21 in the third direction Z which is a normal direction of the nozzle surface 20a. As described above, if the compliance portion 494 is disposed on the same side as the nozzle 21 with respect to the individual flow path 200, it is possible to provide the compliance portion 494 in a region where the nozzle 21 is not provided, and it is possible to provide the compliance portion 494 having a relatively wide area. In addition, if the compliance portion 494 and the nozzle 21 are disposed on the same side with respect to the individual flow path 200, the compliance portion 494 is disposed at a position close to the individual flow path 200, and thus the compliance portion 494 is capable of effectively absorbing a fluctuation in the pressure of the ink in the individual flow path 200.

In addition, two compliance portions 494 of the embodiment are provided, as illustrated in FIG. 1, in one compliance substrate 49. Naturally, the compliance substrate 49 is not limited to the configuration, and the compliance substrate 49 may be independently provided for each of the compliance portions 494.

In addition, the flow path formation substrate 10, the communication plate 15, the nozzle plate 20, the compliance substrate 49, and the like which form the flow path substrate are provided with the individual flow path 200 which communicates with the first common liquid chamber 101 and the second common liquid chamber 102. In the embodiment, a plurality of the individual flow paths 200 arranged side by side in the first direction X include a first individual flow path 200A that communicates with the first common liquid chamber 101 and has the first nozzle 21A and the first pressure chamber 12A, and a second individual flow path 200B that communicates with the second common liquid chamber 102 and has the second nozzle 21B and the second pressure chamber 12B. The first individual flow path 200A and the second individual flow path 200B are alternately disposed in the first direction X.

The first individual flow path 200A includes a first supply path 18A; the first pressure chamber 12A; a first communication path 19A; and the first nozzle 21A.

The first supply path 18A is a flow path through which the first pressure chamber 12A communicates with the first common liquid chamber 101. The first supply path 18A is provided along the third direction Z such that one end of the first supply path 18A on the Z2 side communicates with the first narrow width portion 16a of the first communication portion 16 forming the first common liquid chamber 101 and the other end on the Z1 side communicates with one end of the first pressure chamber 12A in the second direction Y.

The first pressure chamber 12A is provided, as described above, in the flow path formation substrate 10. A Z1 side opening of the first pressure chamber 12A is sealed with the vibrating plate 50, and part of a Z2 side opening of the first pressure chamber 12A is covered with the communication plate 15.

The first communication path 19A is a flow path through which the first pressure chamber 12A communicates with the first nozzle 21A. The first communication path 19A extends in the third direction Z, which is the normal direction of the nozzle surface 20a, such that one end of the first communication path 19A on the Z1 side communicates with the other end of the first pressure chamber 12A in the second direction Y and the other end on the Z2 side communicates with the first nozzle 21A provided in the nozzle plate 20.

The first nozzle 21A is provided to communicate with the other end of the first communication path 19A on the Z2 side, and to be open in the nozzle surface 20a of the nozzle plate 20 on the Z2 side to communicate with the outside.

In addition, the first communication path 19A is formed such that an opening of the first communication path 19A which is close to the first nozzle 21A is closer to the second pressure chamber 12B than an opening thereof which is close to the first pressure chamber 12A. Herein, the fact that the first communication path 19A is formed such that the opening close to the first nozzle 21A is closer to the second pressure chamber 12B than the opening close to the first pressure chamber 12A implies that in a plan view from the third direction Z, the opening of the first communication path 19A which is close to the first nozzle 21A is disposed at a position to further deviate toward the second pressure chamber 12B in the second direction Y than the opening of the first communication path 19A which is close to the first pressure chamber 12A. By the way, in the plan view from the third direction Z, the opening of the first communication path 19A which is close to the first nozzle 21A may partially overlap the opening close to the first pressure chamber 12A. However, it is not the case that in the first communication path 19A, either one of the opening close to the first nozzle 21A and the opening close to the first pressure chamber 12A completely overlaps the other.

In the embodiment, the first communication path 19A includes a first flow path 201 that communicates at one end with the first pressure chamber 12A and is provided to penetrate the first communication plate 151 in the third direction Z; a second flow path 202 that communicates with the other end of the first flow path 201 and extends between the first communication plate 151 and the second communication plate 152 along the second direction Y; and a third flow path 203 that communicates with the second flow path 202 and is provided to penetrate the second communication plate 152 in the third direction Z. Namely, the fact that the first communication path 19A extends in the third direction Z which is the normal direction of the nozzle surface 20a includes a case where the second flow path 202, which is a flow path provided along a direction orthogonal to the third direction Z, namely, along an in-plane direction of the nozzle surface 20a, is provided in the middle of the first communication path 19A.

In the embodiment, the second flow path 202 is formed by providing a recessed portion in the second communication plate 152 and covering an opening of the recessed portion of the second communication plate 152 with the first communication plate 151. Naturally, the second flow path 202 is not specifically limited to being formed by the method, and may be obtained by forming a recessed portion in the first communication plate 151, or may be obtained by forming recessed portions in both of the first communication plate 151 and the second communication plate 152, respectively.

As described above, if the second flow path 202 extending in the second direction Y is provided in the middle of the first communication path 19A, it is possible to move the third flow path 203 toward the second pressure chamber 12B in the second direction Y. It is possible to widen the width of a portion, which is close to the nozzle 21, of the first communication portion 16, which forms the first common liquid chamber 101, toward the nozzle 21 in the second direction Y by moving the third flow path 203 toward the second pressure chamber 12B. Namely, it is possible to provide the first wide width portion 16b, which is formed by widening the width of a portion, which is close to the nozzle 21, of the first communication portion 16 toward the nozzle 21 in the second direction Y, by providing the first communication path 19A in such a manner as to be bent in the middle thereof.

By the way, in order to widen the area of the first compliance portion 494A, it is possible to consider also a configuration where the width of the opening of a Z2 side surface of the first common liquid chamber 101 is widened opposite to the second pressure chamber 12B in the second direction Y. However, if the width of the first common liquid chamber 101 is widened opposite to the second pressure chamber 12B, the size of the communication plate 15 is increased in the second direction Y. In the embodiment, since the first communication path 19A is formed such that the opening close to the first nozzle 21A is closer to the second pressure chamber 12B than the opening close to the first pressure chamber 12A, it is possible to widen the Z2 side opening of the first common liquid chamber 101 toward the second pressure chamber 12B, and thus an increase in the size of the communication plate 15 in the second direction Y is prevented. Therefore, it is possible to widen the area of the first compliance portion 494A. By the way, as described above, a space for mounting the flexible cable 120 and the lead electrode 90 leading out from the piezoelectric actuator 300 is required above a Z1 side surface of the flow path formation substrate 10 between the first pressure chamber 12A and the second pressure chamber 12B. For this reason, the first communication path 19A of the embodiment is provided under a space for mounting the flexible cable 120 and the piezoelectric actuator 300, and thus it is possible to prevent an increase in the sizes of the flow path formation substrate 10 and the communication plate 15 in the second direction Y, and it is possible to provide the first compliance portion 494A having a relatively wide area by widening the width of the first common liquid chamber 101 in the second direction Y.

In addition, if in the first communication path 19A, the opening close to the first nozzle 21A is disposed closer to the second pressure chamber 12B than the opening close to the first pressure chamber 12A, it is possible to reduce the size the nozzle plate 20. Namely, if the first communication path 19A is provided on a straight line along the third direction Z, since it is necessary to cover the opening of the first communication path 19A with the nozzle plate 20, it is necessary to provide the nozzle plate 20 having an area which is wide toward the first common liquid chamber 101. However, in the embodiment, since the opening of the first communication path 19A is positioned close to the second pressure chamber 12B, the nozzle plate 20 may be provided having an area to cover the opening of the first communication path 19A, and it is possible to reduce the size of the nozzle plate 20.

Incidentally, preferably, an end portion, which is close to the first common liquid chamber 101, of the nozzle plate 20 is positioned closer to the nozzle 21 than an edge portion, which is close to the first common liquid chamber 101, of the opening of the first communication path 19A which is close to the first pressure chamber 12A. Accordingly, it is possible to further reduce the size of the nozzle plate 20.

In addition, in the plan view from the first direction X which is the side by side arrangement direction of the nozzle 21, preferably, a gap di between the opening, which is close to the first nozzle 21A, of the first communication path 19A of the first individual flow path 200A and the first common liquid chamber 101 is less than or equal to a gap d₂ between the opening, which is close to the first pressure chamber 12A, of the first communication path 19A and the first common liquid chamber 101 in the second direction Y which is the in-plane direction of the nozzle surface 20a. Namely, preferably, the gap d₁ between the third flow path 203 and the first wide width portion 16b is less than or equal to the gap d₂ between the first flow path 201 and the first narrow width portion 16a in the second direction Y. Incidentally, the gap d₂ between the first flow path 201 and the first narrow width portion 16a is defined by the length of the first pressure chamber 12A in the second direction Y. However, since the second flow path 202 is provided in the middle of the first communication path 19A, regardless of the length of the first pressure chamber 12A, it is possible to provide the third flow path 203 and the first wide width portion 16b at positions where both become proximate to each other. Since it is possible to bring the third flow path 203 proximate to the first wide width portion 16b while leaving a portion required to bond together the compliance substrate 49 and the communication plate 15, it is possible to form the gap di between the third flow path 203 and the first wide width portion 16b, which is less than or equal to the gap d₂ between the first flow path 201 and the first narrow width portion 16a in the second direction Y. Accordingly, it is possible to provide the first compliance portion 494A having a relatively wide area by widening the width of the first wide width portion 16b relatively greatly.

The second individual flow path 200B includes a second supply path 18B; the second pressure chamber 12B; a second communication path 19B; and the second nozzle 21B.

The second supply path 18B is a flow path through which the second pressure chamber 12B communicates with the second common liquid chamber 102. The second supply path 18B is provided along the third direction Z such that one end of the second supply path 18B on the Z2 side communicates with the second narrow width portion 17a of the second communication portion 17 forming the second common liquid chamber 102 and the other end on the Z1 side communicates with one end of the second pressure chamber 12B in the second direction Y.

The second pressure chamber 12B is provided, as described above, in the flow path formation substrate 10. A Z1 side opening of the second pressure chamber 12B is sealed with the vibrating plate 50, and part of a Z2 side opening of the second pressure chamber 12B is covered with the communication plate 15.

The second communication path 19B is a flow path through which the second pressure chamber 12B communicates with the second nozzle 21B. The second communication path 19B extends in the third direction Z, which is the normal direction of the nozzle surface 20a, such that one end of the second communication path 19B on the Z1 side communicates with the other end of the second pressure chamber 12B in the second direction Y and the other end on the Z2 side communicates with the second nozzle 21B provided in the nozzle plate 20.

The second nozzle 21B is provided to communicate with the other end of the second communication path 19B on the Z2 side, and open in the nozzle surface 20a of the nozzle plate 20 on the Z2 side to communicate with the outside.

In addition, the second communication path 19B is formed such that an opening of the second communication path 19B which is close to the second nozzle 21B is closer to the first pressure chamber 12A than an opening thereof which is close to the second pressure chamber 12B. Herein, the fact that the second communication path 19B is formed such that the opening close to the second nozzle 21B is closer to the first pressure chamber 12A than the opening close to the second pressure chamber 12B implies that in the plan view from the third direction Z, the opening of the second communication path 19B which is close to the second nozzle 21B is disposed at a position to further deviate toward the first pressure chamber 12A in the second direction Y than the opening of the second communication path 19B which is close to the second pressure chamber 12B. By the way, in the plan view from the third direction Z, the opening of the second communication path 19B which is close to the second nozzle 21B may partially overlap the opening close to the second pressure chamber 12B. However, it is not the case that in the second communication path 19B, either one of the opening close to the second nozzle 21B and the opening close to the second pressure chamber 12B completely overlaps the other.

In the embodiment, the second communication path 19B includes a fourth flow path 204 that communicates at one end with the second pressure chamber 12B and is provided to penetrate the first communication plate 151 in the third direction Z; a fifth flow path 205 that communicates with the other end of the fourth flow path 204 and extends between the first communication plate 151 and the second communication plate 152 along the second direction Y; and a sixth flow path 206 that communicates with the fifth flow path 205 and is provided to penetrate the second communication plate 152 in the third direction Z. Namely, the fact that the second communication path 19B extends in the third direction Z which is the normal direction of the nozzle surface 20a includes a case where a flow path, which is provided along a direction orthogonal to the third direction Z, namely, along in the in-plane direction of the nozzle surface 20a, is provided in the middle of the second communication path 19B.

In the embodiment, the fifth flow path 205 is formed by providing a recessed portion in the second communication plate 152 and covering an opening of the recessed portion of the second communication plate 152 with the first communication plate 151. Naturally, the fifth flow path 205 is not specifically limited to being formed by the method, and may be obtained by forming a recessed portion in the first communication plate 151, or may be obtained by forming recessed portions in both of the first communication plate 151 and the second communication plate 152, respectively.

As described above, if the fifth flow path 205 extending in the second direction Y is provided in the middle of the second communication path 19B, it is possible to move the sixth flow path 206 toward the first pressure chamber 12A in the second direction Y. It is possible to widen the width of a portion, which is close to the nozzle 21, of the second communication portion 17, which forms the second common liquid chamber 102, toward the nozzle 21 in the second direction Y by moving the sixth flow path 206 toward the first pressure chamber 12A. Namely, it is possible to provide the second wide width portion 17b, which is formed by widening the width of a portion, which is close to the nozzle 21, of the second communication portion 17 toward the nozzle 21 in the second direction Y, by providing the second communication path 19B in such a manner as to be bent in the middle thereof.

By the way, in order to widen the area of the second compliance portion 494B, it is possible to consider also a configuration where the width of the opening of a Z2 side surface of the second common liquid chamber 102 is widened opposite to the first pressure chamber 12A in the second direction Y. However, if the width of the second common liquid chamber 102 is widened opposite to the first pressure chamber 12A, the size of the communication plate 15 is increased in the second direction Y. In the embodiment, since the second communication path 19B is formed such that the opening close to the second nozzle 21B is closer to the first pressure chamber 12A than the opening close to the second pressure chamber 12B, it is possible to widen the Z2 side opening of the second common liquid chamber 102 toward the first pressure chamber 12A, and thus an increase in the size of the communication plate 15 in the second direction Y is prevented. Therefore, it is possible to widen the area of the second compliance portion 494B. By the way, as described above, since a space for mounting the flexible cable 120 and the lead electrode 90 leading out from the piezoelectric actuator 300 is required above a Z1 side surface of the flow path formation substrate 10 between the first pressure chamber 12A and the second pressure chamber 12B, the second communication path 19B of the embodiment is provided under a space for mounting the flexible cable 120 and the piezoelectric actuator 300, and thus it is possible to prevent an increase in the sizes of the flow path formation substrate 10 and the communication plate 15 in the second direction Y, and it is possible to provide the second compliance portion 494B having a relatively wide area by widening the width of the second common liquid chamber 102 in the second direction Y.

In addition, if in the second communication path 19B, the opening close to the second nozzle 21B is disposed closer to the first pressure chamber 12A than the opening close to the second pressure chamber 12B, it is possible to reduce the size the nozzle plate 20. Namely, if the second communication path 19B is provided on a straight line along the third direction Z, since it is necessary to cover the opening of the second communication path 19B with the nozzle plate 20, it is necessary to provide the nozzle plate 20 having an area which is wide toward the second common liquid chamber 102. However, in the embodiment, since the opening of the second communication path 19B is positioned close to the first pressure chamber 12A, the nozzle plate 20 may be provided having an area to cover the opening of the second communication path 19B, and it is possible to reduce the size of the nozzle plate 20.

In addition, in the plan view from the first direction X which is the side by side arrangement direction of the nozzle 21, preferably, a gap d₃ between the opening, which is close to the second nozzle 21B, of the second communication path 19B of the second individual flow path 200B and the second common liquid chamber 102 is less than or equal to a gap d₄ between the opening, which is close to the second pressure chamber 12B, of the second communication path 19B and the second common liquid chamber 102 in the second direction Y which is the in-plane direction of the nozzle surface 20a. Namely, preferably, the gap d₃ between the sixth flow path 206 and the second wide width portion 17b is less than or equal to the gap d₄ between the fourth flow path 204 and the second narrow width portion 17a in the second direction Y. Incidentally, the gap d₄ between the fourth flow path 204 and the second narrow width portion 17a is defined by the length of the second pressure chamber 12B in the second direction Y. However, since the fifth flow path 205 is provided in the middle of the second communication path 19B, regardless of the length of the second pressure chamber 12B, it is possible to provide the sixth flow path 206 and the second wide width portion 17b at positions where both become proximate to each other. Since it is possible to bring the sixth flow path 206 proximate to the second wide width portion 17b while leaving a portion required to bond together the compliance substrate 49 and the communication plate 15, it is possible to form the gap d₃ between the sixth flow path 206 and the second wide width portion 17b, which is less than or equal to the gap d₄ between the fourth flow path 204 and the second narrow width portion 17a in the second direction Y. Accordingly, it is possible to provide the second compliance portion 494B having a relatively wide area by widening the width of the second wide width portion 17b relatively greatly.

In addition, since the opening, which is close to the first nozzle 21A, of the first communication path 19A and the opening, which is close to the second nozzle 21B, of the second communication path 19B can be provided proximate to each other in the second direction Y, it is possible to close a distance between the first nozzle 21A and the second nozzle 21B in the second direction Y.

Incidentally, preferably, an end portion, which is close to the second common liquid chamber 102, of the nozzle plate 20 is positioned closer to the nozzle 21 than an edge portion, which is close to the second common liquid chamber 102, of the opening of the second communication path 19B which is close to the second pressure chamber 12B. Accordingly, it is possible to further reduce the size of the nozzle plate 20.

As described above, the ink jet type recording head 1 which is one example of the liquid ejecting head of the embodiment includes a flow path substrate in which a flow path is formed, and the piezoelectric actuator 300 which is an energy generating element for inducing a change in the pressure of a liquid in the flow path. The flow path includes the first common liquid chamber 101 and the second common liquid chamber 102 which are the common liquid chamber, and the plurality of individual flow paths 200 which communicate with the first common liquid chamber 101 and the second common liquid chamber 102. The individual flow path 200 includes the nozzle 21 that communicates with the outside; the pressure chamber 12 in which a pressure change is induced by the piezoelectric actuator 300; and the first communication path 19A and the second communication path 19B which are communication paths that extend in the third direction Z which is the normal direction of the nozzle surface 20a in which the nozzle 21 opens, and that communicate with the nozzle 21 and the pressure chamber 12. The individual flow path 200 has the first individual flow path 200A having the first pressure chamber 12A as the pressure chamber 12, and the second individual flow path 200B having the second pressure chamber 12B as the pressure chamber 12. The first pressure chamber 12A and the second pressure chamber 12B are disposed at positions which do not overlap each other in the plan view from the side by side arrangement direction of the nozzle 21. The opening, which communicates with the nozzle 21, of the first communication path 19A which is the communication path of the first individual flow path 200A is positioned closer to the second pressure chamber 12B than the opening communicating with the first pressure chamber 12A. The opening, which communicates with the nozzle 21, of the second communication path 19B which is the communication path of the second individual flow path 200B is positioned closer to the first pressure chamber 12A than the opening communicating with the second pressure chamber 12B. The widths of the openings, which are close to the nozzle 21, of the first common liquid chamber 101 and the second common liquid chamber 102 are further widened toward the nozzle 21 than the widths of the openings close to the pressure chamber 12.

As described above, if the opening of the first communication path 19A which is close to the first nozzle 21A is disposed closer to the second pressure chamber 12B than the opening close to the first pressure chamber 12A, and the opening of the second communication path 19B which is close to the second nozzle 21B is disposed closer to the first pressure chamber 12A than the opening close to the second pressure chamber 12B, it is possible to further widen the widths of the openings, which are close to the nozzle 21, of the first common liquid chamber 101 and the second common liquid chamber 102 toward the nozzle 21, namely, toward a space between the first pressure chamber 12A and the second pressure chamber 12B than the openings close to the pressure chamber 12. Therefore, it is possible to prevent an increase in the size of the flow path substrate, which is caused by widening the widths of the first common liquid chamber 101 and the second common liquid chamber 102.

In addition, since the opening, which is close to the first nozzle 21A, of the first communication path 19A and the opening, which is close to the second nozzle 21B, of the second communication path 19B can be provided proximate to each other in the second direction Y, it is possible to reduce the size of the nozzle plate 20, it is possible to reduce the costs, and it is possible to close the distance between the first nozzle 21A and the second nozzle 21B in the second direction Y.

In addition, in the recording head 1 of the embodiment, preferably, the common liquid chamber includes the first common liquid chamber 101 and the second common liquid chamber 102. Preferably, the first individual flow path 200A communicates with at least the first common liquid chamber 101 of the common liquid chamber, and the second individual flow path 200B communicates with at least the second common liquid chamber 102 of the common liquid chamber. In the plan view from the first direction X which is the side by side arrangement direction, preferably, in the in-plane direction of the nozzle surface 20a, the gap d₁ between the opening, which is close to the nozzle 21, of the first communication path 19A which is the communication path of the first individual flow path 200A and the first common liquid chamber 101 is less than or equal to the gap d₂ between the opening, which is close to the first pressure chamber 12A, of the first communication path 19A and the first common liquid chamber 101, and the gap d₃ between the opening, which is close to the nozzle 21, of the second communication path 19B which is the communication path of the second individual flow path 200B and the second common liquid chamber 102 is less than or equal to the gap d₄ between the opening, which is close to the second pressure chamber 12B, of the second communication path 19B and the second common liquid chamber 102. Accordingly, it is possible to further widen the widths of portions of the first common liquid chamber 101 and the second common liquid chamber 102 toward the nozzle 21, and it is possible to provide the compliance portion 494 having a relatively wide area.

In addition, in the recording head 1 of the embodiment, the common liquid chamber has the first narrow width portion 16a and the second narrow width portion 17a that are the narrow width portion which is provided close to the pressure chamber 12 in the third direction Z that is the normal direction of the nozzle surface 20a, and the first wide width portion 16b and the second wide width portion 17b that are the wide width portion which is provided close to the nozzle surface 20a and the width of which is further widened toward the nozzle 21 than the widths of the first narrow width portion 16a and the second narrow width portion 17a. A side wall of the common liquid chamber which is close to the nozzle 21 is provided with the first step 16c that is the step formed by the first narrow width portion 16a and the first wide width portion 16b, and the second step 17c that is the step formed by the second narrow width portion 17a and the second wide width portion 17b.

In addition, in the recording head 1 of the embodiment, preferably, the nozzle 21 is provided in the nozzle plate 20, and the end portion, which is close to the common liquid chamber, of the nozzle plate 20 is positioned closer to the nozzle 21 than the edge portion, which is close to the common liquid chamber, of the opening, which is close to the pressure chamber 12, of the communication path. Namely, the end portion, which is close to the first common liquid chamber 101, of the nozzle plate 20 is positioned closer to the first nozzle 21A than the edge portion, which is close to the first common liquid chamber 101, of the opening of the first communication path 19A which is close to the first pressure chamber 12A. In addition, the end portion, which is close to the second common liquid chamber 102, of the nozzle plate 20 is positioned closer to the second nozzle 21B than the edge portion, which is close to the second common liquid chamber 102, of the opening of the second communication path 19B which is close to the second pressure chamber 12B. Accordingly, it is possible to further reduce the size of the nozzle plate 20, and to reduce the costs.

In addition, in the recording head 1 of the embodiment, the compliance portion 494 capable of absorbing the pressure of the ink which is a liquid is provided on the wall surface, the width of which is widened and is close to the nozzle 21 in the third direction Z which is the normal direction of the nozzle surface 20a, of the common liquid chamber.

As described above, if the compliance portion 494 is disposed on the same side as the nozzle 21 with respect to the individual flow path 200, it is possible to provide the compliance portion 494 in a region where the nozzle 21 is not provided, and it is possible to provide the compliance portion 494 having a relatively wide area. In addition, it is possible to dispose the compliance portion 494 at a location relatively close to the pressure chamber 12, and the compliance portion 494 is capable of effectively absorbing a fluctuation in the pressure of the ink in the individual flow path 200.

Incidentally, in the embodiment, the first common liquid chamber 101 and the second common liquid chamber 102 are independently provided; however, the first common liquid chamber 101 and the second common liquid chamber 102 may communicate with each other through end portions thereof in the second direction Y. Namely, the same ink may be discharged from the first nozzle 21A and the second nozzle 21B.

In addition, in the embodiment, the first nozzle 21A and the second nozzle 21B are disposed so as to deviate from each other in the first direction X; however, the present disclosure is not specifically limited to the disposition. The first nozzle 21A and the second nozzle 21B may be disposed such that the positions thereof in the first direction X are the same position.

Furthermore, the first common liquid chamber 101 and the first communication path 19A may be disposed at positions where parts thereof overlap each other in the third direction Z. Similarly, the second common liquid chamber 102 and the second communication path 19B may be disposed at positions where parts thereof overlap each other in the third direction Z.

### Embodiment 2

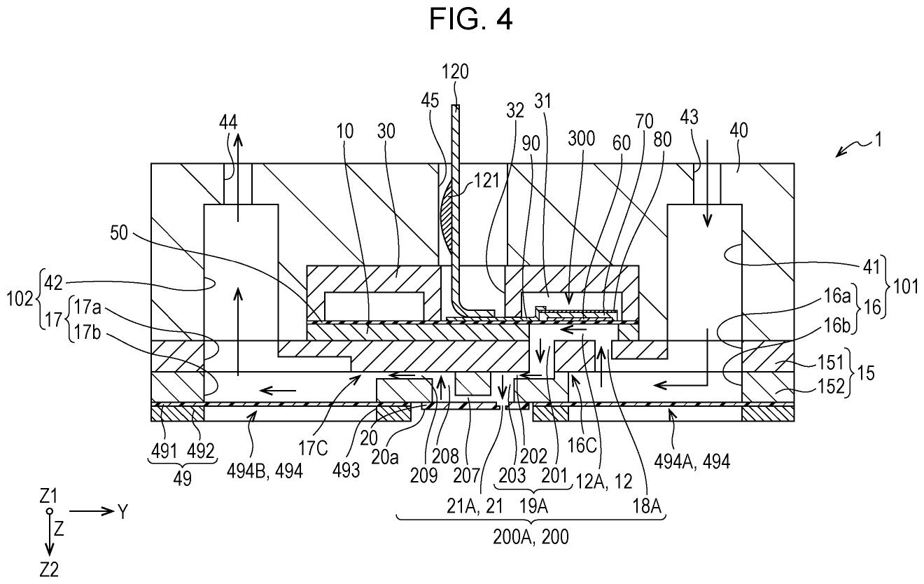

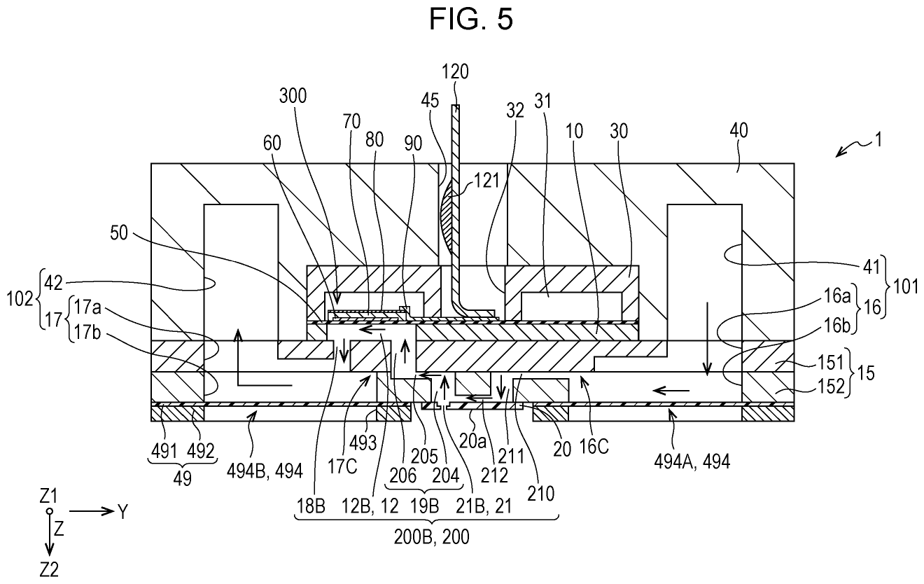

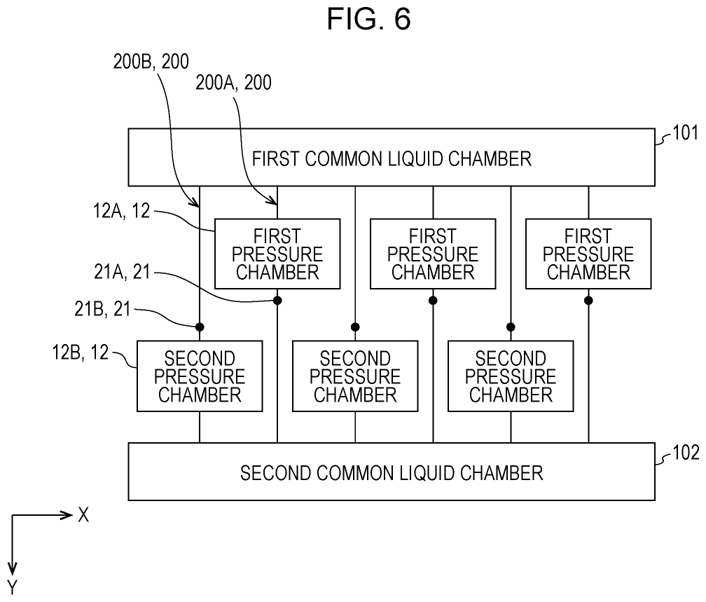

FIG. 4 is a cross-sectional view of an ink jet type recording head which is one example of a liquid ejecting head according to Embodiment 2 of the present disclosure which is taken along a line IV-IV in FIG. 1. FIG. 5 is a cross-sectional view of the recording head of Embodiment 2 which is taken along a line V-V in FIG. 1. In addition, FIG. 6 is a block diagram schematically illustrating flow paths of Embodiment 2. Incidentally, the same reference signs are assigned to the same members as those in the embodiment described above, and the duplicated description will be omitted.

As illustrated in FIGS. 4 and 5, the flow path formation substrate 10, the communication plate 15, the nozzle plate 20, the compliance substrate 49, and the case member 40 which are flow path substrates are provided with the first common liquid chamber 101, the second common liquid chamber 102, and a plurality of the individual flow paths 200 that communicate with the first common liquid chamber 101 and the second common liquid chamber 102 and delivers an ink of the first common liquid chamber 101 to the second common liquid chamber 102.

Similar to Embodiment 1 described above, the first communication portion 16 of the first common liquid chamber 101 has the first narrow width portion 16a and the first wide width portion 16b.

In addition, similar to Embodiment 1 described above, the second communication portion 17 of the second common liquid chamber 102 has the second narrow width portion 17a and the second wide width portion 17b.

In addition, the case member 40 is provided with an inlet port 43 which communicates with the first liquid chamber portion 41 and through which the ink flows into the first liquid chamber portion 41, and an outlet port 44 which communicates with the second liquid chamber portion 42 and through which the ink flows out from the second liquid chamber portion 42.

Furthermore, the individual flow path 200 of the embodiment communicates with the first common liquid chamber 101 and the second common liquid chamber 102, is provided for each of the nozzles 21, and includes the nozzle 21. As described above, three individual flow paths 200 adjacent to each other in the first direction X which is the side by side arrangement direction of the nozzle 21 are provided to communicate with the first common liquid chamber 101 and the second common liquid chamber 102. Namely, the plurality of individual flow paths 200 provided for each of the nozzles 21 are provided to communicate only with the first common liquid chamber 101 and the second common liquid chamber 102. The plurality of individual flow paths 200 do not communicate with parts other than the first common liquid chamber 101 and the second common liquid chamber 102. Namely, in the embodiment, flow paths provided with one nozzle 21 and one pressure chamber 12 are referred to as the individual flow path 200, and the individual flow paths 200 are provided communicating only with the first common liquid chamber 101 and the second common liquid chamber 102.

In addition, flow paths of the individual flow path 200 which are closer to the first common liquid chamber 101 than the nozzle 21 are referred to as upstream flow paths, and flow paths of the individual flow path 200 which are closer to the second common liquid chamber 102 than the nozzle 21 are referred to as downstream flow paths.

Furthermore, in the embodiment, the plurality of individual flow paths 200 arranged side by side in the first direction X include a first individual flow path 200A having the first nozzle 21A, and a second individual flow path 200B having the second nozzle 21B. The first individual flow path 200A and the second individual flow path 200B are alternately disposed in the first direction X.

Herein, the first individual flow path 200A includes the first supply path 18A; the first pressure chamber 12A; the first communication path 19A; the first nozzle 21A; a seventh flow path 207; an eighth flow path 208; and a ninth flow path 209.

Since the first supply path 18A and the first pressure chamber 12A are the same as those in the Embodiment 1 described above, the duplicated description will be omitted.

In addition, similar to Embodiment 1 described above, the first communication path 19A has the first flow path 201; the second flow path 202; and the third flow path 203.

The seventh flow path 207 extends between the second communication plate 152 and the nozzle plate 20 along the second direction Y in the in-plane direction of the nozzle surface 20a so as for one end of the seventh flow path 207 to communicate with the first communication path 19A. The seventh flow path 207 is formed by providing a recessed portion in the second communication plate 152 and covering an opening of the recessed portion with the nozzle plate 20. Incidentally, the seventh flow path 207 is not specifically limited to being formed by the method, and may be formed by providing a recessed portion in the nozzle plate 20 and covering the recessed portion with the second communication plate 152, or may be formed by providing recessed portions in both of the second communication plate 152 and the nozzle plate 20, respectively.

The eighth flow path 208 is provided such that one end of the eighth flow path 208 on the Z2 side communicates with the seventh flow path 207 and the eighth flow path 208 penetrates the second communication plate 152 in the third direction.

The ninth flow path 209 extends between the first communication plate 151 and the second communication plate 152 along the second direction Y in the in-plane direction of the nozzle surface 20a such that one end of the ninth flow path 209 communicates with the eighth flow path 208 and the other end communicates with the second common liquid chamber 102. The ninth flow path 209 of the embodiment is formed by providing a recessed portion in the second communication plate 152 and covering the recessed portion with the first communication plate 151. Naturally, the ninth flow path 209 may be formed by providing a recessed portion in the first communication plate 151 and covering the recessed portion with the second communication plate 152, or may be formed by providing recessed portions in both of the first communication plate 151 and the second communication plate 152, respectively.

In addition, the ninth flow path 209 is provided to communicate with a side surface of the second wide width portion 17b of the second communication portion 17. Namely, the ninth flow path 209 is provided to communicate with the side surface of the second wide width portion 17b of the second communication portion 17 at a position corresponding to the second step 17c.

The first individual flow path 200A described above has the first supply path 18A, the first pressure chamber 12A, the first communication path 19A, the first nozzle 21A, the seventh flow path 207, the eighth flow path 208, and the ninth flow path 209 in the order from an upstream region communicating with the first common liquid chamber 101 toward a downstream region communicating with the second common liquid chamber 102. Namely, in the embodiment, as illustrated in FIG. 6, in the first individual flow path 200A, the first pressure chamber 12A and the first nozzle 21A are disposed in the order from the upstream region toward the downstream region with respect to the flow of the ink from the first common liquid chamber 101 toward the second common liquid chamber 102.

In the first individual flow path 200A described above, the ink flows from the first common liquid chamber 101 to the second common liquid chamber 102 through the first individual flow path 200A. In addition, when a change in the pressure of the ink in the first pressure chamber 12A is induced by driving the piezoelectric actuator 300, and the pressure of the ink in the first nozzle 21A is increased, ink droplets are discharged from the first nozzle 21A to the outside. When the ink flows from the first common liquid chamber 101 to the second common liquid chamber 102 through the first individual flow path 200A, the piezoelectric actuator 300 may be driven, and when the ink does not flow from the first common liquid chamber 101 to the second common liquid chamber 102 through the first individual flow path 200A, the piezoelectric actuator 300 may be driven. In addition, the ink may temporarily flow from the second common liquid chamber 102 to the first common liquid chamber 101 due to a pressure change induced by driving the piezoelectric actuator 300.

Incidentally, in the embodiment, flow paths of the first individual flow path 200A which are positioned upstream of the first nozzle 21A, namely, the first communication path 19A, the first pressure chamber 12A, the first supply path 18A which communicate with the first common liquid chamber 101 are referred to as first upstream flow paths. In addition, flow paths of the first individual flow path 200A which are positioned downstream of the first nozzle 21A, namely, the seventh flow path 207, the eighth flow path 208, and the ninth flow path 209 which communicate with the second common liquid chamber 102 are referred to as first downstream flow paths.

The second individual flow path 200B includes a tenth flow path 210; an eleventh flow path 211; a twelfth flow path 212; the second nozzle 21B; the second communication path 19B; the second pressure chamber 12B; and the second supply path 18B.

The tenth flow path 210 extends between the first communication plate 151 and the second communication plate 152 along the second direction Y in the in-plane direction of the nozzle surface 20a so as for one end of the tenth flow path 210 to communicate with the first common liquid chamber 101. The tenth flow path 210 of the embodiment is formed by providing a recessed portion in the second communication plate 152 and covering the recessed portion with the first communication plate 151. Naturally, the tenth flow path 210 may be formed by providing a recessed portion in the first communication plate 151 and covering the recessed portion with the second communication plate 152, or may be formed by providing recessed portions in both of the first communication plate 151 and the second communication plate 152, respectively.

The tenth flow path 210 described above and the first pressure chamber 12A of the first individual flow path 200A are disposed at different positions in the third direction Z which is the normal direction of the nozzle surface 20a. Specifically, the first pressure chamber 12A is provided close to the Z1 side with respect to the first communication plate 151, and the tenth flow path 210 is provided close to the Z2 side with respect to the first communication plate 151. The first pressure chamber 12A and the tenth flow path 210 are disposed at the different positions in the third direction Z. For this reason, even though the first pressure chamber 12A and the tenth flow path 210 are disposed proximate to each other in the first direction X, the thickness of a partition wall partitioning the first pressure chamber 12A is prevented from being reduced, and the partition wall of the first pressure chamber 12A is prevented from, by being deformed, absorbing the pressure of the ink in the first pressure chamber 12A, and thus it is possible to prevent the occurrence of variations in discharge characteristics. In addition, even though the first pressure chamber 12A and the tenth flow path 210 are disposed such that at least the parts of the first pressure chamber 12A and the tenth flow path 210 overlap each other in the plan view from the third direction Z, since the first pressure chamber 12A and the tenth flow path 210 are disposed at the different positions in the third direction Z, the first pressure chamber 12A and the tenth flow path 210 do not communicate with each other. Incidentally, in the embodiment, the tenth flow path 210 is disposed at a position where the tenth flow path 210 does not overlap the first pressure chamber 12A in the plan view from the third direction Z.

In addition, since the tenth flow path 210 is provided between the first communication plate 151 and the second communication plate 152, the tenth flow path 210 is provided to be open in a side surface of the first wide width portion 16b of the first communication portion 16. Namely, the tenth flow path 210 is provided to communicate with the side surface of the first wide width portion 16b of the first communication portion 16 at a position corresponding to the first step 16c. For this reason, even though air bubbles stay at the first step 16c, the air bubbles staying at the first step 16c are capable of flowing out to the second common liquid chamber 102 via the second individual flow path 200B. Therefore, air bubbles are prevented from staying in the first common liquid chamber 101, and it is possible to prevent poor ink supply to the pressure chamber 12 which is caused by the growth of air bubbles in the first common liquid chamber 101, or a defect in discharging ink droplets which is caused due to air bubbles flowing into the pressure chamber 12 at an unexpected timing.

The eleventh flow path 211 is provided such that one end of the eleventh flow path 211 on the Z1 side communicates with the tenth flow path 210 and the eleventh flow path 211 penetrates the second communication plate 152 in the third direction. Namely, the eleventh flow path 211 extends between from the nozzle 21 to the first common liquid chamber 101 in the third direction Z which is the normal direction of the nozzle surface 20a.

The twelfth flow path 212 extends between the second communication plate 152 and the nozzle plate 20 along the second direction Y in the in-plane direction of the nozzle surface 20a so as for one end of the twelfth flow path 212 to communicate with the eleventh flow path 211. The twelfth flow path 212 is formed by providing a recessed portion in the second communication plate 152 and covering an opening of the recessed portion with the nozzle plate 20. Incidentally, the twelfth flow path 212 is not specifically limited to being formed by the method, and may be formed by providing a recessed portion in the nozzle plate 20 and covering the recessed portion with the second communication plate 152, or may be formed by providing recessed portions in both of the second communication plate 152 and the nozzle plate 20, respectively.

The seventh flow path 207 and the twelfth flow path 212 are alternately disposed in the first direction X between the communication plate 15 and the nozzle plate 20. A resolution defined by alternately disposing the seventh flow path 207 and the twelfth flow path 212 in the first direction X is referred to as a second resolution. The second resolution of the seventh flow path 207 and the twelfth flow path 212 is larger than the first resolution of the first pressure chamber 12A or the second pressure chamber 12B. For example, if the first pressure chamber 12A is formed with the first resolution of 300 dpi and the second pressure chamber 12B is formed with the first resolution of 300 dpi, the seventh flow path 207 and the twelfth flow path 212 are formed with the second resolution of 600 dpi. Therefore, if the first resolution of each of the first pressure chamber 12A and the second pressure chamber 12B is set smaller than the second resolution of the seventh flow path 207 and the twelfth flow path 212, it is possible to widen the opening widths of the first pressure chamber 12A and the second pressure chamber 12B in the first direction X, and it is possible to increase the excluded volume of the pressure chamber 12.

Similar to Embodiment 1 described above, the second communication path 19B has the fourth flow path 204; the fifth flow path 205; and the sixth flow path 206.

Since the second nozzle 21B, the second communication path 19B, the second supply path 18B, and the second pressure chamber 12B are the same as those in the Embodiment 1 described above, the duplicated description will be omitted.

The second individual flow path 200B described above has the tenth flow path 210, the eleventh flow path 211, the twelfth flow path 212, the second nozzle 21B, the second communication path 19B, the second pressure chamber 12B, and the second supply path 18B in the order from the upstream region communicating with the first common liquid chamber 101 toward the downstream region communicating with the second common liquid chamber 102. Namely, in the embodiment, as illustrated in FIG. 6, in the second individual flow path 200B, the second nozzle 21B and the second pressure chamber 12B are disposed in the order from the upstream region toward the downstream region with respect to the flow of the ink from the first common liquid chamber 101 toward the second common liquid chamber 102. Namely, the order of disposition of the pressure chamber 12 and the nozzle 21 with respect to the flow of the ink from the first common liquid chamber 101 toward the second common liquid chamber 102 differs between the first individual flow path 200A and the second individual flow path 200B. In the embodiment, since each of the individual flow paths 200 is provided with one pressure chamber 12 and one nozzle 21, the order of disposition of the pressure chamber 12 and the nozzle 21 is reversed between the first individual flow path 200A and the second individual flow path 200B.

In the second individual flow path 200B described above, the ink flows from the first common liquid chamber 101 to the second common liquid chamber 102 through the second individual flow path 200B. In addition, when a change in the pressure of the ink in the second pressure chamber 12B is induced by driving the piezoelectric actuator 300, and the internal pressure of the second nozzle 21B is increased, ink droplets are discharged from the second nozzle 21B to the outside. When the ink flows from the first common liquid chamber 101 to the second common liquid chamber 102 through the second individual flow path 200B, the piezoelectric actuator 300 may be driven, and when the ink does not flow from the first common liquid chamber 101 to the second common liquid chamber 102 through the second individual flow path 200B, the piezoelectric actuator 300 may be driven. In addition, the ink may temporarily flow from the second common liquid chamber 102 to the first common liquid chamber 101 due to a pressure change induced by driving the piezoelectric actuator 300. By the way, the discharge of ink droplets from the second nozzle 21B is determined by the pressure of the ink in the second nozzle 21B. The pressure of the ink in the second nozzle 21B is determined by the pressure of the ink flowing from the first common liquid chamber 101 toward the second common liquid chamber 102, namely, a so-called circulation pressure and the pressure of the ink that flows from the second pressure chamber 12B toward the second nozzle 21B due to the piezoelectric actuator 300 being driven.

For example, with respect to the flow of the ink from the first common liquid chamber 101 toward the second common liquid chamber 102, due to a fluctuation in the pressure of the ink in the second pressure chamber 12B, the ink may flow backward from the second pressure chamber 12B toward the second nozzle 21B, and ink droplets may be discharged from the second nozzle 21B. As described above, the fact that the ink flows backward from the second pressure chamber 12B toward the second nozzle 21B implies that the pressure of circulation from the first common liquid chamber 101 toward the second common liquid chamber 102 is low, and thus it is possible to reduce a pressure loss of the individual flow path 200 by reducing the pressure of circulation to a relatively low pressure. If the pressure loss of each of the individual flow paths 200 is reduced, since it is possible to reduce a difference in pressure loss between the individual flow paths 200, it is possible to reduce variations in the discharge characteristics of ink droplets to be discharged from each of the nozzles 21.

In addition, for example, with respect to the flow of the ink from the first common liquid chamber 101 toward the second common liquid chamber 102, due to a fluctuation in the pressure of the ink in the second pressure chamber 12B, the ink may be discharged from the second nozzle 21B without the backflow of the ink from the second pressure chamber 12B toward the second nozzle 21B. In this case, since the flow of the ink from the second pressure chamber 12B toward the second nozzle 21B is not formed, it is difficult for air bubbles to flow backward from the second pressure chamber 12B toward the second nozzle 21B, and it is difficult for air bubbles to cause a defect in discharging ink droplets from the second nozzle 21B.

Incidentally, in the embodiment, flow paths of the second individual flow path 200B which are positioned upstream of the second nozzle 21B, namely, the tenth flow path 210, the eleventh flow path 211, and the twelfth flow path 212 which communicate with the first common liquid chamber 101 are referred to as second upstream flow paths. In addition, flow paths of the second individual flow path 200B which are positioned downstream of the second nozzle 21B, namely, the second communication path 19B, the second pressure chamber 12B, and the second supply path 18B which communicate with the second common liquid chamber 102 are referred to as second downstream flow paths.

The first individual flow path 200A and the second individual flow path 200B described above are, as illustrated in FIG. 6, alternately provided in the first direction X. Namely, regardless of the positions of the pressure chamber 12 and the nozzle 21 with respect to the flow of the ink from the first common liquid chamber 101 toward the second common liquid chamber 102, it is possible to discharge ink droplets from the nozzle 21 due to a fluctuation in the internal pressure of the pressure chamber 12. Namely, even though as in the first individual flow path 200A, the first pressure chamber 12A is disposed upstream and the first nozzle 21A is disposed downstream, and even though as in the second individual flow path 200B, the second nozzle 21B is disposed upstream and the second pressure chamber 12B is disposed downstream, it is possible to selectively discharge ink droplets from both of the first nozzle 21A and the second nozzle 21B due to a fluctuation in the pressure of the ink in the pressure chamber 12. For this reason, as described above, if with respect to the flow of the ink from the first common liquid chamber 101 toward the second common liquid chamber 102, the first individual flow path 200A and the second individual flow path 200B between which the order of the pressure chamber 12 and the nozzle 21 differs are alternately disposed in the first direction X, it is possible to change the position of the pressure chamber 12 between the first individual flow path 200A and the second individual flow path 200B, namely, to dispose the first pressure chamber 12A and the second pressure chamber 12B at different positions in the second direction Y. Therefore, it is possible to form the pressure chamber 12 having a wide width in the first direction X in each of the individual flow paths 200, and it is possible to dispose the pressure chambers 12 at a high density in the first direction X. Namely, if the first pressure chamber 12A and the second pressure chamber 12B are disposed at the different positions in the second direction Y, it is possible to thicken a partition wall between the first pressure chambers 12A that are arranged side by side in the first direction X, and it is possible to thicken a partition wall between the second pressure chambers 12B that are arranged side by side in the first direction X. Therefore, even though each of the first pressure chamber 12A and the second pressure chamber 12B is formed having a wide width in the first direction X, it is possible to prevent a reduction in the rigidity of the partition wall, it is possible to improve the discharge characteristics of ink droplets, namely, to increase the weight of ink droplets by increasing the excluded volume, and it is possible to prevent the occurrence of cross talk caused by a reduction in the rigidity of the partition wall.

In addition, even though the first pressure chambers 12A and the second pressure chambers 12B are disposed at a high density in the first direction X, it is possible to prevent a reduction in the rigidity of the partition wall, and it is possible to prevent the occurrence of cross talk caused by a reduction in the rigidity of the partition wall.

By the way, for example, if the second individual flow path 200B is not provided and only the first individual flow paths 200A are arranged side by side in the first direction X, when the first pressure chambers 12A are disposed at a high density in the first direction X, the thickness of the partition wall between the first pressure chambers 12A adjacent to each other is reduced, and the rigidity of the partition wall is reduced. As described above, if the rigidity of the partition wall is reduced, cross talk occurs due to the deformation of the partition wall. Namely, if ink droplets are simultaneously discharged from the nozzles 21 on both sides of the nozzle 21 discharging ink droplets, pressures are applied, at the same timing, from both sides to the partition wall between the first pressure chambers 12A adjacent to each other.

In this case, since pressures are applied from both sides to the partition wall, regardless of the rigidity of the partition wall, it is difficult for the partition wall to be deformed. On the other hand, if ink droplets are not discharged from the nozzles 21 on both sides of the nozzle 21 discharging ink droplets, a pressure is applied only to one side of the partition wall between the first pressure chambers 12A adjacent to each other. At that time, if the rigidity of the partition wall is low, the partition wall is deformed to absorb a pressure fluctuation, and the discharge characteristics of the ink droplets deteriorate. For this reason, variations in the discharge characteristics of ink droplets occur depending on a difference in condition such as which nozzle discharging ink droplets among the plurality of nozzles 21. Therefore, if only the first pressure chamber 12A is provided, it is not possible to form the first pressure chamber 12A having a wide width in the first direction X, and it is not possible to dispose the first pressure chambers 12A at a high density in the first direction X.

In the embodiment, since the first pressure chamber 12A and the second pressure chamber 12B are disposed at the different positions in the second direction Y, it is possible to increase the thickness of the partition wall between the first pressure chambers 12A, which are adjacent to each other in the first direction X, to a relatively large thickness, and it is possible to increase the thickness of the partition wall between the second pressure chambers 12B, which are adjacent to each other in the first direction X, to a relatively large thickness. For this reason, even though each of the first pressure chamber 12A and the second pressure chamber 12B is formed having a wide width in the first direction X, it is possible to prevent a reduction in the rigidity of the partition wall between the first pressure chambers 12A and in the rigidity of the partition wall between the second pressure chambers 12B. Therefore, it is possible to increase the volumes of the first pressure chamber 12A and the second pressure chamber 12B by preventing a size increase of the flow path substrate in the first direction X, it is possible to improve the discharge characteristics of ink droplets, particularly, to increase the weight of ink droplets by increasing the excluded volume by the driving of the piezoelectric actuator 300, and it is possible to prevent the occurrence of cross talk caused by a reduction in the rigidity of the partition wall.

In addition, even though a gap between the first pressure chamber 12A and the second pressure chamber 12B in the first direction X is shortened, since it is possible to prevent a reduction in the rigidity of the partition wall between the first pressure chambers 12A and in the rigidity of the partition wall between the second pressure chambers 12B, it is possible to dispose the first pressure chambers 12A and the second pressure chambers 12B at a high density in the first direction X. Therefore, it is possible to attain a size reduction of the flow path substrate in the first direction X and to improve the discharge characteristics of ink droplets by increasing the excluded volume of the pressure chamber 12, it is possible to dispose the pressure chambers 12 at a high density in the first direction X and to dispose the nozzles 21 at a high density, and it is possible to prevent the occurrence of cross talk caused by a reduction in the rigidity of the partition wall.

In addition, in the embodiment, the first nozzle 21A is disposed at a position where the first nozzle 21A communicates with the other end of the first communication path 19A that communicates at one end with the first pressure chamber 12A and is aligned along the third direction Z. For this reason, it is possible to increase the weight of ink droplets discharged from the first nozzle 21A by making the cross-sectional area of the first communication path 19A from the first pressure chamber 12A to the first nozzle 21A relatively large, and reducing the flow path resistance of the first communication path 19A.

Similarly, in the embodiment, the second nozzle 21B is disposed at a position where the second nozzle 21B communicates with the other end of the second communication path 19B that communicates at one end with the second pressure chamber 12B and is aligned along the third direction Z. For this reason, it is possible to increase the weight of ink droplets discharged from the second nozzle 21B by making the cross-sectional area of the second communication path 19B from the second pressure chamber 12B to the second nozzle 21B relatively large, and reducing the flow path resistance of the second communication path 19B.

Namely, in the embodiment, if the first nozzle 21A and the second nozzle 21B are disposed at different positions in the second direction Y so as for the first nozzle 21A and the second nozzle 21B to directly communicate with the first communication path 19A and the second communication path 19B, respectively, and the nozzles 21 are disposed in a so-called staggered pattern in the first direction X, it is possible to increase the weight of ink droplets discharged from the first nozzle 21A and the second nozzle 21B.

Naturally, the first nozzle 21A may be disposed in the middle of the seventh flow path 207 so as to communicate therewith, and the second nozzle 21B may be disposed in the middle of the twelfth flow path 212 so as to communicate therewith. However, since each of the seventh flow path 207 and the twelfth flow path 212 is restricted in having a large flow path cross-sectional area, particularly, a large height in the third direction Z due to the thickness of the communication plate 15 in the third direction Z, the seventh flow path 207 and the twelfth flow path 212 are likely to have a larger flow path resistance compared to the first communication path 19A and the second communication path 19B. Therefore, there occurs a concern such as the weight of ink droplets discharged from the first nozzle 21A and the second nozzle 21B being relatively small.

In addition, in the embodiment, the individual flow path 200 is provided such that the flow path resistance of the upstream flow path closer to the first common liquid chamber 101 than the nozzle 21 is equal to the flow path resistance of the downstream flow path closer to the second common liquid chamber 102 than the nozzle 21.

Namely, the first upstream flow path and the first downstream flow path of the first individual flow path 200A have the same flow path resistance. Namely, the first upstream flow path and the first downstream flow path are formed such that the sum of the flow path resistances of the first supply path 18A, the first pressure chamber 12A, and the first communication path 19A forming the first upstream flow path is equal to the sum of the flow path resistances of the seventh flow path 207, the eighth flow path 208, and the ninth flow path 209 forming the first downstream flow path. Herein, the flow path resistance of the first upstream flow path and the first downstream flow path is determined by a flow path cross-sectional area, the flow path length, and the shape of the flow path.

In addition, the second upstream flow path and the second downstream flow path of the second individual flow path 200B have the same flow path resistance. Namely, the second upstream flow path and the second downstream flow path are formed such that the sum of the flow path resistances of the tenth flow path 210, the eleventh flow path 211, and the twelfth flow path 212 forming the second upstream flow path is equal to the sum of the flow path resistances of the second communication path 19B, the second pressure chamber 12B, and the second supply path 18B forming the second downstream flow path.

In the embodiment, the first individual flow path 200A and the second individual flow path 200B have shapes inverted with respect to an ink flow direction from the first common liquid chamber 101 toward the second common liquid chamber 102. Namely, the first upstream flow path of the first individual flow path 200A and the second downstream flow path of the second individual flow path 200B are provided so as to have the same shape and the same flow path resistance. The first downstream flow path of the first individual flow path 200A and the second upstream flow path of the second individual flow path 200B are provided so as to have the same shape and the same flow path resistance.

As described above, if the first upstream flow path and the first downstream flow path of the first individual flow path 200A have the same flow path resistance, and the second upstream flow path and the second downstream flow path of the second individual flow path 200B have the same flow path resistance, even though the first individual flow path 200A and the second individual flow path 200B have shapes inverted with respect to the ink flow direction from the first common liquid chamber 101 toward the second common liquid chamber 102, it is possible to equalize the flow path resistances of the first upstream flow path equal and the second upstream flow path from the first common liquid chamber to the nozzle 21. Therefore, it is possible to prevent the occurrence of variations in the discharge characteristics of ink droplets to be discharged from the first nozzle 21A of the first individual flow path 200A and in the discharge characteristics of ink droplets to be discharged from the second nozzle 21B of the second individual flow path 200B, and it is possible to simplify the structures of the flow paths.

In addition, if the flow path resistance of the first downstream flow path of the first individual flow path 200A is made equal to that of the second downstream flow path of the second individual flow path 200B, it is possible to equalize the discharge characteristics of ink droplets to be discharged from the nozzles 21. Namely, if ink droplets are simultaneously discharged from the plurality of nozzles 21, since the ink is supplied to the pressure chambers 12 from both of the first common liquid chamber 101 and the second common liquid chamber 102, it is possible to prevent the occurrence of variations in the amount of ink supply, and to prevent the occurrence of variations in the discharge characteristics of ink droplets by making the flow path resistance of the first downstream flow path equal to that of the second downstream flow path.

By the way, for example, if the flow path resistance of the first upstream flow path is different from that of the first downstream flow path in the first individual flow path 200A, when the second individual flow path 200B is formed by inverting the first individual flow path 200A, since the first downstream flow path of the first individual flow path 200A becomes the second upstream flow path of the second individual flow path 200B, the flow path resistances of the first upstream flow path and the second upstream flow path from the first common liquid chamber 101 to the nozzle 21 become different from each other. For this reason, there occur variations in the discharge characteristics of ink droplets to be discharged from the first nozzle 21A of the first individual flow path 200A and the second nozzle 21B of the second individual flow path 200B. In addition, in order to form the first upstream flow path and the second upstream flow path having the same flow path resistance, the second upstream flow path must be formed having a cross-sectional area, a flow path length, a shape, and the like different from those of the first downstream flow path, which causes complexity.

In addition, in a state where the ink flows from the first common liquid chamber 101 to the second common liquid chamber 102 via the individual flow paths 200, in a non-discharge period where ink droplets are not discharged from the nozzles 21, preferably, a difference of the internal ink pressure, relative to atmospheric pressure, of each of the nozzles 21 of the individual flow paths 200 adjacent to each other in the first direction X which is the side by side arrangement direction of the nozzle 21 is from −2% to +2%. For example, if the atmospheric pressure is 1,013 hPa, the internal pressure of the nozzle 21 is approximately 1,000 hPa. Therefore, a difference in internal ink pressure between the nozzles 21 adjacent to each other is approximately a maximum of 20 hPa.

As described above, if in a non-discharge period, the difference in internal ink pressure between the first nozzle 21A and the second nozzle 21B which are adjacent to each other in the first direction X is relatively small such as from −2% to +2%, it is possible to prevent the occurrence of variations in the discharge characteristics of ink droplets to be discharged from the first nozzle 21A and in the discharge characteristics of ink droplets to be discharged from the second nozzle 21B. As described above, in order to attain a relatively small difference in internal ink pressure between the first nozzle 21A and the second nozzle 21B, it is necessary to make the flow path resistance from the first common liquid chamber 101 to the first nozzle 21A equal to the flow path resistance from the first common liquid chamber 101 to the second nozzle 21B such that the difference in internal ink pressure between the nozzles 21 is from −2% to +2%. If the flow path resistance from the first common liquid chamber 101 to the first nozzle 21A and the flow path resistance from the first common liquid chamber 101 to the second nozzle 21B are formed such that the difference in internal ink pressure between the nozzles 21 is from −2% to +2%, since the first individual flow path 200A and the second individual flow path 200B have the same shape and the shapes inverted with respect to the ink flow direction, it is possible to simplify the structure of the individual flow path 200, and to dispose the first pressure chamber 12A and the second pressure chamber 12B at different positions in the second direction Y.

In addition, the flow path resistance of the first upstream flow path and the first downstream flow path and the flow path resistance of the second upstream flow path and the second downstream flow path, or the difference of internal ink pressure between two nozzles 21 adjacent to each other in the first direction X is not limited to that described above. For example, the flow path resistances of the first upstream flow path and the first downstream flow path, and the flow path resistances of the second upstream flow path and the second downstream flow path may be different from each other, or the pressure of the ink in the first nozzle 21A and the pressure of the ink in the second nozzle 21B may be less than −2% or greater than +2%. In the case described above, different voltages may be applied to the piezoelectric actuators 300 of the individual flow paths 200 adjacent to each other in the side by side arrangement direction of the nozzle 21.

For example, if the first individual flow path 200A and the second individual flow path 200B have inverted structures, when the flow path resistance of the first upstream flow path is larger than that of the first downstream flow path, the pressure of the ink in the first nozzle 21A becomes low, and the weight of ink droplets to be discharged from the first nozzle 21A becomes small. On the other hand, if the first individual flow path 200A and the second individual flow path 200B have inverted structures, the flow path resistance of the second upstream flow path is smaller than the flow path resistance of the second downstream flow path, and the pressure of the ink in the second nozzle 21B becomes low. Therefore, the weight of ink droplets to be discharged from the second nozzle 21B becomes large. Therefore, a voltage to be applied to the piezoelectric actuator 300 corresponding to the first individual flow path 200A is made relatively higher than a voltage to be applied to the piezoelectric actuator 300 corresponding to the second individual flow path 200B. Incidentally, in order to make a voltage to be applied to the piezoelectric actuator 300 corresponding to the first individual flow path 200A relatively higher than a voltage to be applied to the piezoelectric actuator 300 corresponding to the second individual flow path 200B, for example, the voltage to be applied to the piezoelectric actuator 300 corresponding to the first individual flow path 200A may be made high, the voltage to be applied to the piezoelectric actuator 300 corresponding to the second individual flow path 200B may be made low, or both voltages may be adjusted with respect to a reference voltage. Accordingly, even though there occurs a relatively large difference of internal ink pressure between the first nozzle 21A and the second nozzle 21B, it is possible to reduce variations in the weight of ink droplets to be discharged from the first nozzle 21A and the second nozzle 21B, and to improve print quality by adjusting a voltage to be applied to the piezoelectric actuator 300.

As described above, the ink jet type recording head 1 which is one example of the liquid ejecting head of the embodiment includes a flow path substrate in which a flow path is formed, and the piezoelectric actuator 300 which is an energy generating element for inducing a change in the pressure of a liquid in the flow path. The flow path includes the first common liquid chamber 101 and the second common liquid chamber 102 which are the common liquid chamber, and the plurality of individual flow paths 200 which communicate with the first common liquid chamber 101 and the second common liquid chamber 102. The individual flow path 200 includes the nozzle 21 that communicates with the outside; the pressure chamber 12 in which a pressure change is induced by the piezoelectric actuator 300; and the first communication path 19A and the second communication path 19B which are communication paths that extend in the third direction Z which is the normal direction of the nozzle surface 20a in which the nozzle 21 opens, and that communicate with the nozzle 21 and the pressure chamber 12.

The individual flow path 200 has the first individual flow path 200A having the first pressure chamber 12A as the pressure chamber 12, and the second individual flow path 200B having the second pressure chamber 12B as the pressure chamber 12. The first pressure chamber 12A and the second pressure chamber 12B are disposed at positions which do not overlap each other in the plan view from the side by side arrangement direction of the nozzle 21. The opening, which communicates with the nozzle 21, of the first communication path 19A which is the communication path of the first individual flow path 200A is positioned closer to the second pressure chamber 12B than the opening communicating with the first pressure chamber 12A. The opening, which communicates with the nozzle 21, of the second communication path 19B which is the communication path of the second individual flow path 200B is positioned closer to the first pressure chamber 12A than the opening communicating with the second pressure chamber 12B. The widths of the openings, which are close to the nozzle 21, of the first common liquid chamber 101 and the second common liquid chamber 102 are further widened toward the nozzle 21 than the widths of the openings close to the pressure chamber 12.

As described above, if the opening of the first communication path 19A which is close to the first nozzle 21A is disposed closer to the second pressure chamber 12B than the opening close to the first pressure chamber 12A, and the opening of the second communication path 19B which is close to the second nozzle 21B is disposed closer to the first pressure chamber 12A than the opening close to the second pressure chamber 12B, it is possible to further widen the widths of the openings, which are close to the nozzle 21, of the first common liquid chamber 101 and the second common liquid chamber 102 toward the nozzle 21, namely, toward a space between the first pressure chamber 12A and the second pressure chamber 12B than the openings close to the pressure chamber 12. Therefore, it is possible to prevent an increase in the size of the flow path substrate, which is caused by widening the widths of the first common liquid chamber 101 and the second common liquid chamber 102.

In addition, since the opening, which is close to the first nozzle 21A, of the first communication path 19A and the opening, which is close to the second nozzle 21B, of the second communication path 19B can be provided proximate to each other in the second direction Y, it is possible to reduce the size of the nozzle plate 20, it is possible to reduce the costs, and it is possible to close the distance between the first nozzle 21A and the second nozzle 21B in the second direction Y.

In addition, in the recording head 1 of the embodiment, the common liquid chamber has the first narrow width portion 16a and the second narrow width portion 17a that are the narrow width portion which is provided close to the pressure chamber 12 in the third direction Z that is the normal direction of the nozzle surface 20a, and the first wide width portion 16b and the second wide width portion 17b that are the wide width portion which is provided close to the nozzle surface 20a and the width of which is further widened toward the nozzle 21 than the widths of the first narrow width portion 16a and the second narrow width portion 17a. A side wall of the common liquid chamber which is close to the nozzle 21 is provided with the first step 16c that is the step formed by the first narrow width portion 16a and the first wide width portion 16b, and the second step 17c that is the step formed by the second narrow width portion 17a and the second wide width portion 17b.

In the recording head 1 of the embodiment, the common liquid chamber has the first common liquid chamber 101 and the second common liquid chamber 102, the individual flow path 200 communicates with both of the first common liquid chamber 101 and the second common liquid chamber 102 and supplies the ink as a liquid from the first common liquid chamber 101 to the second common liquid chamber 102, the first individual flow path 200A is provided communicating with the first narrow width portion 16a which is the narrow width portion, and the second individual flow path 200B is provided to communicate with the side surface, which is close to the first narrow width portion 16a, of the first wide width portion 16b which is the wide width portion.

Accordingly, air bubbles staying at the first step 16c are capable of flowing out to the second common liquid chamber 102 via the second individual flow path 200B, and it is possible to prevent a defect in discharging ink droplets by reducing the possibility that air bubbles in the first common liquid chamber 101 grow and enter the pressure chamber 12 at an unexpected timing.

Incidentally, the embodiment employs a configuration where the nozzle plate 20 and the compliance substrate 49 are provided as separate bodies; however, the present disclosure is not limited to the configuration. For example, the nozzle plate 20 may be provided having a size to cover the openings of the first common liquid chamber 101 and the second common liquid chamber 102, and the compliance portion 494 may be provided in part of the nozzle plate 20. The nozzle plate 20 provided with the compliance portion 494 as described above can be manufactured of a resin film such as a polyimide film, or a metallic material such as stainless steel.

As described above, if the compliance portion 494 is provided in part of the nozzle plate 20, since the nozzle plate 20 covers the openings of the first common liquid chamber 101 and the second common liquid chamber 102, the nozzle plate 20 covers spaces between the first common liquid chamber 101 and the nozzle 21 and between the second common liquid chamber 102 and the nozzle 21 which are on a Z2 side of the communication plate 15. For this reason, it is possible to form the ninth flow path 209, the tenth flow path 210, or the like, which is part of the individual flow path 200 communicating with the first common liquid chamber 101 and the second common liquid chamber 102, at a joint interface between the nozzle plate 20 and the communication plate 15.

Since the ninth flow path 209, the tenth flow path 210, or the like which is part of the individual flow path 200 is formed at the joint interface between the nozzle plate 20 and the communication plate 15, it is not necessary to manufacture the communication plate 15 by laminating a plurality of substrates on top of each other, and it is possible to manufacture the communication plate 15 from one piece of substrate. However, if the ninth flow path 209 and the tenth flow path 210 which are part of the individual flow path 200 are formed between the nozzle plate 20 and the communication plate 15, it is difficult for air bubbles staying at the first step 16c to flow out to the second common liquid chamber 102 via the second individual flow path 200B. Therefore, even though the compliance portion 494 is provided in the nozzle plate 20, preferably, the ninth flow path 209 and the tenth flow path 210 are provided between the first communication plate 151 and the second communication plate 152. Accordingly, air bubbles staying at the first step 16c easily flow out to the second common liquid chamber 102 via the second individual flow path 200B, and it is possible to prevent a defect which is caused due to air bubbles staying in the first common liquid chamber 101.

### Other Embodiments

The embodiments of the present disclosure are described above; however, basic configurations of the present disclosure are not limited to the configurations described above.

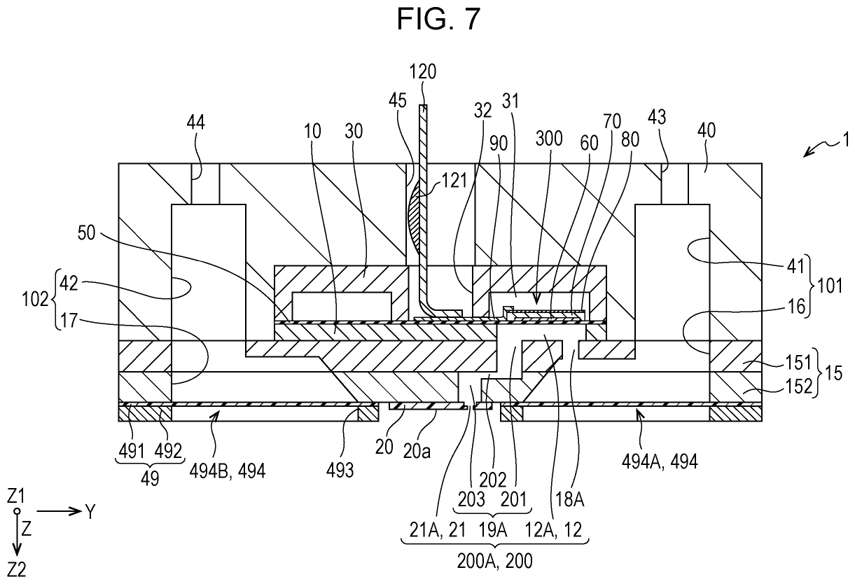

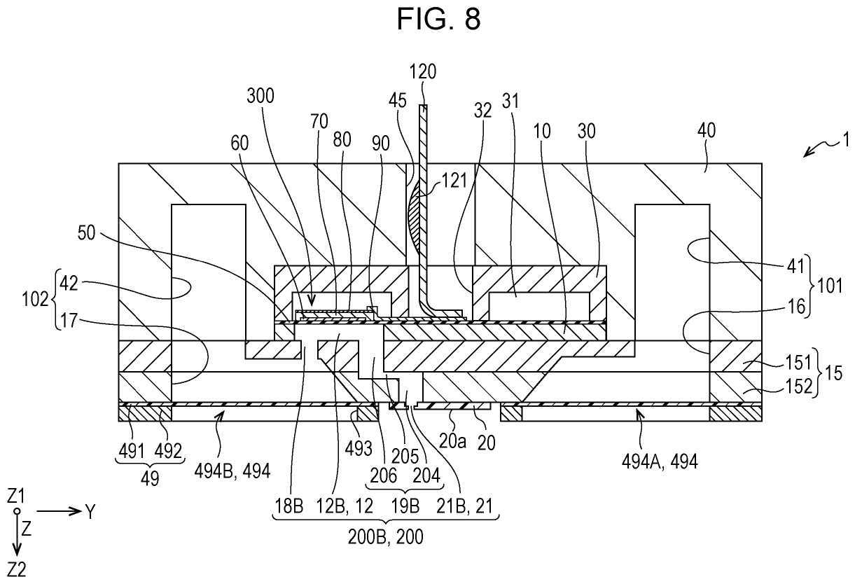

For example, in each of the embodiments described above, since the first narrow width portion 16a and the first wide width portion 16b are provided in the first communication portion 16 of the first common liquid chamber 101, in the first common liquid chamber 101, the area of the opening close to the nozzle 21 can be widened than the area of the opening close to the pressure chamber 12; however, the present disclosure is not specifically limited to the configuration. Herein, a modification example of the first common liquid chamber 101 and the second common liquid chamber 102 will be described with reference to FIGS. 7 and 8. Incidentally, FIG. 7 is a cross-sectional view illustrating a modification example of the recording head which is taken along a line VII-VII in FIG. 1. FIG. 8 is a cross-sectional view illustrating the modification example of the recording head which is taken along a line VIII-VIII in FIG. 1.

As illustrated in FIGS. 7 and 8, a side surface, which is close to the second common liquid chamber 102, of the first communication portion 16 of the first common liquid chamber 101 is provided to be inclined so as for the width of the first communication portion 16 to be widened toward the nozzle 21 in the second direction Y.

Similarly, a side surface, which is close to the first common liquid chamber 101, of the second communication portion 17 of the second common liquid chamber 102 is provided to be inclined so as for the width of the second communication portion 17 to be widened toward the nozzle 21 in the second direction Y.

Even in the configuration described above, it is possible to form the compliance portion 494 having a relatively wide area by widening the areas of the openings, which are close to the Z2 side that is a side close to the nozzle 21, of the first common liquid chamber 101 and the second common liquid chamber 102. In addition, it is possible to prevent air bubbles from staying at a step by inclining the side surface without providing a step in the side surface of the first common liquid chamber 101. Naturally, the side surface which is inclined as described above may be applied only to the side surfaces of the first wide width portion 16b and the second wide width portion 17b.

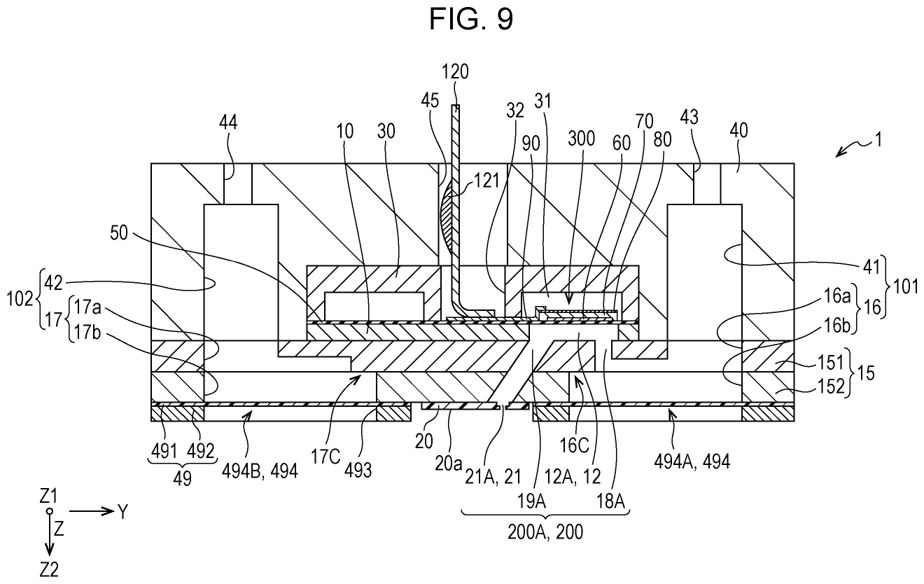

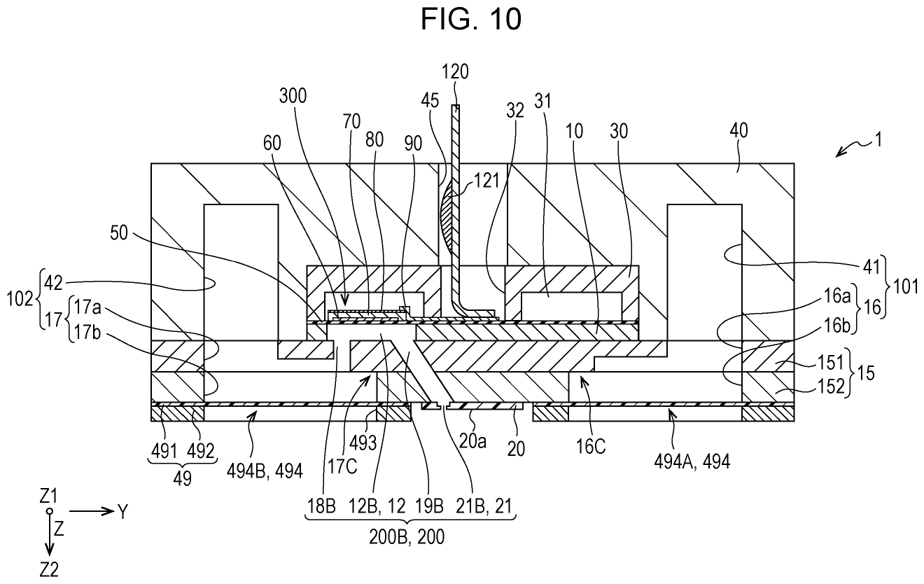

In addition, in Embodiment 1 and Embodiment 2 described above, the first communication path 19A and the second communication path 19B are bent by providing the second flow path 202 and the fifth flow path 205 which are horizontal flow paths in the middle of the first communication path 19A and the second communication path 19B, respectively; however, the present disclosure is not specifically limited to the configuration. Herein, a modification example of the recording head will be described with reference to FIGS. 9 and 10. Incidentally, FIG. 9 is a cross-sectional view illustrating the modification example of the recording head which is taken along a line IX-IX in FIG. 1. FIG. 10 is a cross-sectional view illustrating the modification example of the recording head which is taken along a line X-X in FIG. 1.

As illustrated in FIG. 9, the first communication path 19A is provided to be inclined with respect to the third direction Z. Specifically, the first communication path 19A is provided to be inclined in the second direction Y such that an end portion communicating with the first pressure chamber 12A is positioned close to the first common liquid chamber 101 and another end portion communicating with the first nozzle 21A is positioned close to the second common liquid chamber 102. As described above, even in the case where the first communication path 19A is provided to be inclined, it is possible to form the first communication path 19A such that the opening, which is close to the first nozzle 21A, of the first communication path 19A is closer to the second pressure chamber 12B than the opening, which is close to the first pressure chamber 12A, of the first communication path 19A. Namely, the fact that the opening of the first communication path 19A which is close to the first nozzle 21A is disposed closer to the second pressure chamber 12B than the opening of the first communication path 19A which is close to the first pressure chamber 12A includes the case where the second flow path 202 provided along the in-plane direction of the nozzle surface 20a is provided in the middle of the first communication path 19A as in each of the embodiments described above, and the case where the first communication path 19A is provided to be inclined with respect to the third direction Z as illustrated in FIG. 9.

As described above, if the first communication path 19A is provided inclined with respect to the third direction Z, it is possible to form the first compliance portion 494A having a relatively wide area by widening the width of the opening of the first common liquid chamber 101 on the Z2 side, which is a side close to the nozzle 21, toward the second common liquid chamber 102.

In addition, as illustrated in FIG. 10, the second communication path 19B is provided to be inclined with respect to the third direction Z. Specifically, the second communication path 19B is provided to be inclined in the second direction Y such that an end portion communicating with the second pressure chamber 12B is positioned close to the second common liquid chamber 102 and another end portion communicating with the second nozzle 21B is positioned close to the first common liquid chamber 101. Namely, the fact that the opening of the second communication path 19B which is close to the second nozzle 21B is disposed closer to the first pressure chamber 12A than the opening of the second communication path 19B which is close to the second pressure chamber 12B includes the case where the fifth flow path 205 provided along the in-plane direction of the nozzle surface 20a is provided in the middle of the second communication path 19B as in each of the embodiments described above, and the case where the second communication path 19B is provided to be inclined with respect to the third direction Z as illustrated in FIG. 10.

As described above, if the second communication path 19B is provided inclined with respect to the third direction Z, it is possible to form the second compliance portion 494B having a relatively wide area by widening the width of the opening of the second common liquid chamber 102 on the Z2 side, which is the side close to the nozzle 21, toward the first common liquid chamber 101.

Incidentally, the first communication path 19A and the second communication path 19B illustrated in FIGS. 9 and 10 may be combined with the first common liquid chamber 101 and the second common liquid chamber 102 illustrated in FIGS. 7 and 8. As described above, if the first communication path 19A and the second communication path 19B illustrated in FIGS. 9 and 10 are combined with the first common liquid chamber 101 and the second common liquid chamber 102 illustrated in FIGS. 7 and 8, since the first step 16c and the second step 17c are not provided in the horizontal flow paths such as the second flow path 202 and the fifth flow path 205 along the in-plane direction of the nozzle surface 20a, or the first common liquid chamber 101 and the second common liquid chamber 102, it is not necessary to manufacture the communication plate 15 by laminating a plurality of substrates on top of each other, and it is possible to manufacture the communication plate 15 from one piece of substrate.

Furthermore, the first communication path 19A and the second communication path 19B illustrated in FIGS. 9 and 10, and the first common liquid chamber 101 and the second common liquid chamber 102 illustrated in FIGS. 7 and 8 can be also applied to Embodiment 2 described above.

Furthermore, in each of the embodiments described above, the configuration where the first nozzle 21A and the second nozzle 21B are disposed at different positions in the second direction Y is exemplified; however, the present disclosure is not specifically limited to the configuration. The first nozzle 21A and the second nozzle 21B may be provided at the same position in the second direction Y, namely, may be provided such that the nozzles 21 are disposed on a straight line along the first direction X. By the way, in Embodiment 2 described above, in order to provide the first nozzle 21A and the second nozzle 21B at the same position in the second direction Y, the first nozzle 21A may be provided at a position in the middle of the seventh flow path 207 so as to communicate therewith, and the second nozzle 21B may be provided at a position in the middle of the twelfth flow path 212 so as to communicate therewith. Naturally, even though the first nozzle 21A and the second nozzle 21B are disposed at different positions in the second direction Y, the first nozzle 21A may be provided at a position in the middle of the seventh flow path 207 so as to communicate therewith, and the second nozzle 21B may be provided at a position in the middle of the twelfth flow path 212 so as to communicate therewith.

As described above, if the first nozzle 21A and the second nozzle 21B are disposed at relatively close positions in the second direction Y, turbulent flows generated by ink droplets discharged from the first nozzle 21A and the second nozzle 21B are prevented from affecting each other, and thus it is possible to prevent a deviation in the flying direction of the ink droplets which is caused by the turbulent flows. In addition, if the plurality of nozzles 21 are disposed on a straight line in the first direction X, it is not necessary to adjust the timing of discharging ink droplets from the nozzles 21 so as for the timings to deviate from each other, and it is possible to simplify control of the drive of the piezoelectric actuator 300.

In addition, in each of the embodiments described above, a configuration where one row of the first pressure chamber 12A and one row of the second pressure chamber 12B, namely, two rows in total are provided is exemplified; however, the present disclosure is not limited to the configuration. Two or more rows of the first pressure chambers 12A may be provided, and two or more rows of the second pressure chambers 12B may be provided.

In addition, the piezoelectric actuator 300 and the flexible cable 120 are coupled to each other between the first pressure chamber 12A and the second pressure chamber 12B of the flow path formation substrate 10; however, the present disclosure is not limited to the configuration. A wiring leading out from the piezoelectric actuator 300 may extend to above the protection substrate 30 and coupled to the flexible cable 120 above the protection substrate 30, or the piezoelectric actuator 300 may be directly coupled to the flexible cable 120.

In addition, in each of the embodiments described above, the configuration where one nozzle 21 and one pressure chamber 12 are provided for each of the individual flow paths 200 is exemplified, but the number of the nozzles 21 and the number of the pressure chambers 12 are not specifically limited. Two or more plurality of the nozzles 21 may be provided for one pressure chamber 12, and two or more plurality of the pressure chambers 12 may be provided for one nozzle 21. However, ink droplets are simultaneously discharged in one discharge period from the nozzles 21 provided in one individual flow path 200. Namely, even though the plurality of nozzles 21 are provided in one individual flow path 200, only either of a discharge mode in which ink droplets are simultaneously discharged from the plurality of nozzles 21 and a non-discharge mode in which ink droplets are not simultaneously discharged therefrom is performed.

In addition, in each of the embodiments described above, the flow path substrate has the flow path formation substrate 10, the communication plate 15, the nozzle plate 20, the compliance substrate 49, the case member 40, and the like; however, the present disclosure is not specifically limited to the configuration. The flow path substrate may be one piece of substrate, or may be formed by laminating two or more plurality of pieces of substrates on top of each other. For example, the flow path substrate may include the flow path formation substrate 10 and the nozzle plate 20, and may not include the communication plate 15, the compliance substrate 49, and the case member 40. In addition, one pressure chamber 12 may be formed by a plurality of the flow path formation substrates 10, and the pressure chamber 12, the first common liquid chamber 101, and the second common liquid chamber 102 may be formed in the flow path formation substrate 10.

In addition, in each of the embodiments described above, the piezoelectric actuator 300 which is a thin film type is described as an energy generating element that induces a pressure change in the pressure chamber 12; however, the present disclosure is not specifically limited to the type. It is possible to use, for example, a thick film type piezoelectric actuator formed by a method such as pasting green sheets together, or a longitudinal vibration type piezoelectric actuator in which a piezoelectric material and an electrode forming material are alternately laminated on top of each other and which expands and contracts in an axial direction. In addition, as an energy generating element, it is possible to use, for example, an actuator in which a heating element is disposed in a pressure chamber and discharges liquid droplets from a nozzle by means of bubbles formed by heat of the heating element, or a so-called electrostatic actuator that discharges liquid droplets from a nozzle opening by generating static electricity between a vibrating plate and an electrode, and deforming the vibrating plate with the static electricity.

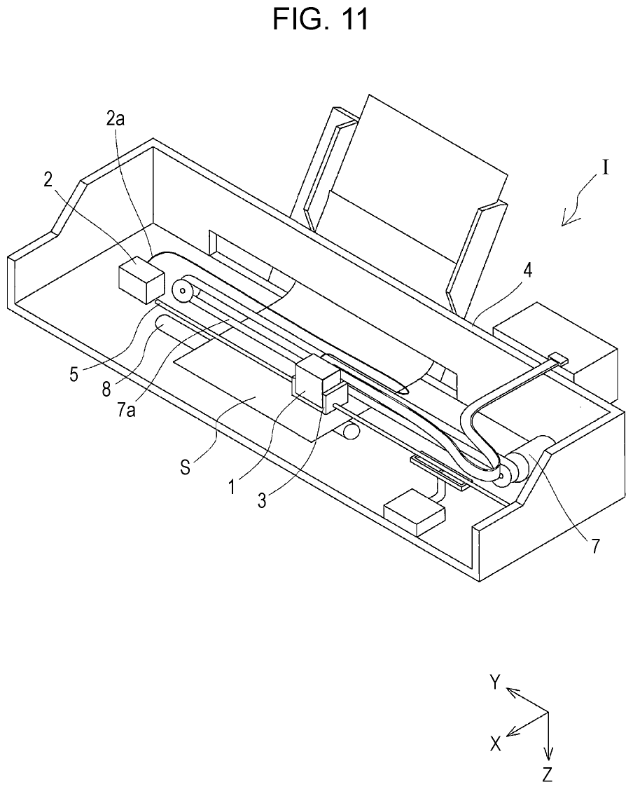

Herein, one example of an ink jet type recording apparatus which is one example of a liquid ejecting apparatus of the embodiment will be described with reference to FIG. 11. Incidentally, FIG. 11 is a view illustrating a schematic configuration of the ink jet type recording apparatus of the present disclosure.

As illustrated in FIG. 11, in an ink jet type recording apparatus I which is one example of the liquid ejecting apparatus, a plurality of the recording heads 1 are mounted on a carriage 3. The carriage 3 on which the recording heads 1 are mounted are provided on a carriage shaft 5 attached to an apparatus main body 4, so as to be movable in an axial direction.

In the embodiment, a movement direction of the carriage 3 is the second direction Y.

In addition, the apparatus main body 4 is provided with a tank 2 which is a storage unit that stores an ink as a liquid. The tank 2 is coupled to the recording heads 1 via a supply pipe 2a such as a tube, and the ink from the tank 2 is supplied to the recording heads 1 via the supply pipe 2a.

If a drive force of a drive motor 7 is transmitted to the carriage 3 via a plurality of gears (not illustrated) and a timing belt 7a, the carriage 3 on which the recording heads 1 are mounted move along the carriage shaft 5. On the one hand, a transport roller 8 as a transport unit is provided in the apparatus main body 4, and a recorded sheet S such as paper which is an ejection target medium is transported by the transport roller 8. Incidentally, the transport unit which transports the recorded sheet S is not limited to the transport roller 8, and may be a belt, a drum, or the like. In the embodiment, a transport direction of the recorded sheet S is the first direction X.

Incidentally, in the ink jet type recording apparatus I described above, a configuration where the recording heads 1 are mounted on the carriage 3 and move in a main scanning direction is exemplified; however, the present disclosure is not specifically limited to the configuration. The present disclosure can be applied, for example, also to a so-called line type recording apparatus that performs printing only by moving the recorded sheet S such as paper in an auxiliary scanning direction in a state where the recording heads 1 are fixed.

In addition, if as in Embodiment 2 described above, the ink circulates between the tank 2 and the recording heads 1, an outlet pipe by which the tank 2 is coupled to the recording heads 1 may be provided, and the ink from the recording heads 1 may return to the tank 2 via the outlet pipe.

Incidentally, in each of the embodiments, the ink jet type recording head and the ink jet type recording apparatus are exemplarily described as one example of the liquid ejecting head and one example of the liquid ejecting apparatus, respectively. The present disclosure is intended for a wide range of liquid ejecting heads and liquid ejecting apparatuses in general, and naturally, can be applied also to liquid ejecting heads or liquid ejecting apparatuses which eject liquids other than an ink. Examples of other liquid ejecting heads include various recording heads used in image recording apparatuses such as a printer, a color material ejecting head used to manufacture color filters such as a liquid crystal display, an electrode material ejecting head used to form electrodes such as an organic EL display and a field emission display (FED), a bioorganic matter ejecting head used to manufacture biochips. The present disclosure can be applied also to liquid ejecting apparatuses including the liquid ejecting heads.

What is claimed is:

1. A liquid ejecting head comprising:
first and second individual flow paths arranged side by side along a first direction;
a first nozzle communicating with the first individual flow path;
a second nozzle communicating with the second individual flow path; and
a first common liquid chamber coupled to one ends of the first and second individual flow paths, wherein
the first and second nozzles have openings in a nozzle surface having a second direction as a normal direction,
the first individual flow path includes a first pressure chamber in which an energy generating element is provided, and a first communication path through which the first pressure chamber communicates with the first nozzle,
the second individual flow path includes a second pressure chamber in which an energy generating element is provided, and a second communication path through which the second pressure chamber communicates with the second nozzle, and
when seen along the second direction, in the first communication path, an end portion close to the first nozzle and another end portion close to the first pressure chamber are disposed at positions which do not overlap each other.

2. The liquid ejecting head according to claim 1, wherein
when seen along the second direction, the end portion in the first communication path which is close to the first nozzle is provided further apart from the first common liquid chamber than the other end portion in the first communication path which is close to the first pressure chamber.

3. The liquid ejecting head according to claim 1, wherein
the first common liquid chamber has a wide width portion that has a relatively large overlap with the first pressure chamber when seen along the second direction, and a narrow width portion that has a relatively small overlap or no overlap with the first pressure chamber when seen along the second direction.

4. The liquid ejecting head according to claim 3, wherein
a compliance portion configured to absorb a pressure of a liquid is provided in the wide width portion.

5. The liquid ejecting head according to claim 1, further comprising:
a second common liquid chamber coupled to the other ends of the first and second individual flow paths.

6. The liquid ejecting head according to claim 5, wherein
when seen along the first direction, the first pressure chamber and the second pressure chamber do not overlap each other.

7. The liquid ejecting head according to claim 6, wherein
when seen along the first direction, the first nozzle and the second nozzle do not overlap each other.

8. The liquid ejecting head according to claim 6, wherein
when seen along the second direction, the first pressure chamber is provided closer to the first common liquid chamber compared to the second common liquid chamber, and
when seen along the second direction, the second pressure chamber is provided closer to the second common liquid chamber compared to the first common liquid chamber.

9. The liquid ejecting head according to claim 8, wherein
when seen along the second direction, an end portion in the second communication path which is close to the second nozzle is provided further apart from the second common liquid chamber than another end portion in the second communication path which is close to the second pressure chamber.

10. A liquid ejecting apparatus comprising:
the liquid ejecting head according to claim 1.
